(19) United States
(12) Patent Application Publication
(10) Pub. No.: US 2004/0052418 A1
(43) Pub. Date: Mar. 18, 2004

(54) Method and apparatus for probabilistic image analysis

(76) Inventor: Bruno DeLean, Roc Escolls (AD)

Correspondence Address: COUDERT BROTHERS LLP, 333 SOUTH HOPE STREET, 23RD FLOOR, LOS ANGELES, CA, 90071, US

(21) Appl. No.: 10/410,750

(22) Filed: Apr. 9, 2003

Related U.S. Application Data
(63) Continuation-in-part of application No. 10/116,839, filed on Apr. 5, 2002.

(51) Int. Cl. G06K 9/62

(52) U.S. Cl. 382/209

(57) ABSTRACT

Embodiments of the present invention are directed to a method and apparatus for probabilistic image analysis. In one embodiment, an image is normalized and filtered. A determination is made regarding the likelihood of the image randomly matching characteristics of the reference image. If the likelihood is smaller than a threshold, the system determines that the image and the reference image match. In one embodiment, the likelihood is determined by using patches of skin in the images. In one embodiment, the likelihood is derived from the coherence of the optical flow computed between the two images. In one embodiment, the image is partitioned into a plurality of pixel regions. A pixel region in one image is mapped to a best-fit region in the other image. A neighbor region of the pixel region is mapped to a best-fit pixel region in the other image. The positional relationship between the pixel region and its neighbor is compared with the positional relationship between the two best-fit pixel regions

### RELATED APPLICATION INFORMATION

This application is a continuation in part of and claims the benefit of U.S. patent application Ser. No. 10/116,839, filed Month Apr. 5, 2002, entitled, “Vision-Based Operating Method And System,” the disclosure of which is hereby incorporated by reference.

### BACKGROUND OF THE INVENTION

1. Field of the Invention

The present invention relates to the field of image analysis, and in particular to a method and apparatus for probabilistic image analysis.

2. Background Art

Computer systems have become nearly ubiquitous, ranging from multi-purpose devices such as servers, personal computers, laptop computers and mainframe computers to special purpose devices such as application specific integrated circuits and processors disposed in a wide range of appliances, tools, and other devices. Computers typically take their inputs from a common set of interfaces, including keyboards, mouse devices, microphones, cameras, sensors, and the like. However, while a range of input devices are known for special purpose computers, processing systems for general purpose computers currently focus on two types of inputs: character- and cursor-based inputs from keyboards, mouse devices, touch screens, and the like, and voice-based inputs from microphones (for speech recognition). While there are many applications for those computers, in certain situations it may be difficult for users to provide the necessary inputs. For example, a child or elderly person may not be sophisticated enough to provide the correct keyboard or voice commands, but may be able to make gestures that have recognizable meaning, such as gestures for help. In other situations there may be no available user, making voice- or character-based instructions unavailable. Nevertheless, changes in a given environment may give sufficient visual data to trigger a need for a relevant action (e.g., smoke in a room triggers a need for an alarm). Thus, a need exists for a general purpose processing system that will accept and operate based on image or visual inputs, either alone, or in combination with conventional inputs.

One area in which visual inputs can be used to advantage is face recognition (or hand recognition, or other biometric recognition). Face recognition technologies are known in which an image is processed in order to determine whether a face matches one or more reference faces, such as for security purposes. Such technologies may be used, for example, to determine whether a user is permitted entry into a home, office, or similar environment. Current facial recognition approaches, which typically involve comparison of facial features between multiple images and calculations that assess the degree of match, are plagued with problems. One problem is the tendency of such systems to produce false positive matches. A false positive result means that an unauthorized user may be permitted entry into a home, for example. The tendency to produce false positive matches means that users who are seeking to be recognized are typically given only a limited number of attempts to be recognized. However, systems may also produce false negatives; thus, the limitations that are necessary to prevent false positives tend to increase the number of false negatives to the point that legitimate users are denied access in many instances. Thus, a need exists for a system that can limit the instance of false positive matches to an arbitrarily low level, so that a user who wants to be recognized can attempt to be recognized as many times as he or she wishes, without fear that an unauthorized user will be permitted entry.

### SUMMARY OF THE INVENTION

Embodiments of the present invention are directed to a method and apparatus for probabilistic image analysis. In one embodiment of the present invention, a vision-based processing system that can take an image from an environment (a “target” image), process the image (optionally without requiring additional user input or interaction) and take an action based on the content of the image is provided. In another embodiment, a non-vision-based processing system is utilized. Various embodiments include processing face images for purposes of securing entry into an environment such as a home or office. Other embodiments analyze biometric data (e.g., images of a face, hand, other body part or portions thereof). Other embodiments include using images to monitor environments, such as for safety purposes. A wide range of embodiments are disclosed herein, some taking advantage of the ability to process images directly, rather than requiring the intervention of a keyboard- or mouse-based user input.

In various embodiments, methods and/or systems for confirming whether an image of a face matches a reference image, wherein the probability of a false positive may be made arbitrarily small, are provided. In some embodiments, such methods and systems allow a user who wishes to be recognized to try as many times as desired until a match occurs, without fear that an unauthorized user will be permitted access.

In some embodiments, provided herein are methods and systems for determining whether an acquired target image matches a reference image. The methods and systems of some embodiments provide for acquiring a digital image for comparison to a reference image; identifying a group of pixels in the acquired image; selecting the pixel group in the reference image that is the best match for the pixel group in the acquired image; repeating the preceding steps for at least one more group of pixels; comparing the relative locations of the selected pixel groups in the reference images and the pixel groups in the acquired image; and determining the probability that the relative locations occurred randomly.

In some embodiments, the methods and systems compare the probability of a random match to a threshold probability for concluding that the images match. The threshold can be set so that the probability of a false positive is arbitrarily low.

In one embodiment of the invention, a comparison is made between a patch of skin of a target person to be identified and a corresponding reference image of a patch of skin from a database of reference images. An analysis is performed to determine if the target person is a member of the population of the members of the database. The use of a patch of skin has shown to be highly accurate and results in almost no false positives and minimal false negatives. The comparison of the patches of skin is based on selected attributes of the patch that can be quantized and compared.

The attributes of the skin can be thought of as a “visual skin print”. In one embodiment, the visual skin print can be comprised of patterns of luminance generated by the texture, shape, and color of the skin. As described below, one technique for using this visual skin print involves digitizing the target image and comparing luminance values of the target and reference images.

In various embodiments, images are filtered, such as by determining the luminance of a pixel based on an average of values of neighboring pixels; comparing the value of the luminance of the pixel to a threshold value; setting the filtered value of the pixel to zero if the luminance is below the threshold; and setting the filtered value of the pixel to one if the luminance is equal to or greater than the threshold value. In various embodiments, images are normalized by positioning known features, such as eyes, at known coordinates.

In various embodiments, methods and systems for determining a match between pixel groups of an acquired image and the pixel groups of the reference image include defining a first vector between the first pixel group of the acquired image and a second pixel group of the acquired image; defining a second vector between the first pixel group of the reference image and the second pixel group of the reference image; and calculating an absolute value of the difference between the first vector and the second vector. This calculation can be done for as many pixel groups as desired.

In various embodiments, the methods and systems described herein provide for comparing the probability of a random match to a threshold probability for concluding that the images match; repeating the comparison steps for a different reference image; and allowing unlimited number of mismatches before allowing a match to one of the reference images. Upon determining a match, the acquired image can be added to the database of reference images to aid further matches.

Another technique used in an embodiment of the present invention is referred to as “optical flow”. It is well known that an initial image may be manipulated, or “morphed” into a second image using various manipulation techniques. In this embodiment, a target image is analyzed with respect to a reference image by morphing the target to become the reference image. The optical flow of this process is the amount of morphing required to turn the target image into the reference image. If the amount of optical flow is “reasonable”, that is, if the steps of morphing could correspond to changes such as, for example, lighting conditions, positioning of the person, aging, make-up, etc., it is assumed that the target image and the reference image have a high probability of coming from the same person. One of the tests of the reasonableness of the morphing is the continuity of the process itself. These tests may be applied to the whole image or to a subset only.

In various embodiments, methods and systems described herein include a processor-based system having an image based-operating system. The system may include a camera, located in an environment, and a computer-based system in data connection with the camera, the computer-based operating system having an operating system that is capable of operating the computer-based system in response to image data acquired by the camera. The operating system may be capable of operating the computer-based system solely based on the image data. The system may be provided along with another system that is capable of receiving instructions from the computer-based system in response to actions taken by the operating system. The other system might be a security system, an alarm system, a communications system, an automated teller system, a banking system, a safe, another camera system, a speaker system, a microphone, a computer, a server, a laptop, a handheld computer, a bluetooth enabled device, an entertainment system, a television, a recorder, an appliance, a tool, an automobile system, a transportation system, a vehicle system, a sensor, an emitter, a transmitter, a transceiver, an antenna, a transponder, a gaming system, a computer network, a home network, a local area network, a wide area network, the Internet, the worldwide web, a satellite system, a cable system, a telecommunications system, a modem, a telephone, or a cellular phone, for example.

In various embodiments the operating system is capable of identifying a characteristic in an image and taking an action based on the characteristic. The characteristic might be a matching face, a matching code, motion, a biometric, a non-match element, a structure in an environment, an emotion of a face, presence of item in an environment, absence of an item in an environment, movement of an item, appearance of a new item in an image, smoke, fire, water, a leak, damage to an environment, action of a person, action of a pet, action of a child, action of an elderly person, a face, a gesture, positioning of a face in front of a camera, change of an image, detection of a face in the image, speech, lip movement, a finger movement, a hand movement, an arm movement, a leg movement, a movement of the body, a movement of the head, a movement of the neck, a shoulder movement, or a gait, for example. In embodiments, the characteristic is matching a face and wherein the action is opening a security system.

In various embodiments, the methods and systems can be disposed in many environments, such as, for example, an airport, an airplane, a transportation venue, a bus, a bus station, a train, a train station, a rental car venue, a car, a truck, a van, a workplace, a venue, a ticketed venue, a sports arena, a concert arena, a stadium, a sports venue, a concert venue, a museum, a store, a home, a pool, a gym, a health club, a golf club, a tennis club, a club, a parking lot, a computer, laptop, an electronic commerce environment, an ATM, a storage location, a safe deposit box, a bank, or an office.

In one embodiment where the system matches a face in order to allow an action, the system may also require further confirmation, such as providing a key, entering a code, inserting a card, recognizing a voice, recognizing a fingerprint, and recognizing another biometric.

In various embodiments, methods and systems may further include locating a camera in an environment; capturing an image of the environment, the image comprising an image of an event of the environment; providing a vision-based operating system for processing the image; processing the image to identify a characteristic of the event; and taking an action based on the characteristic.

For example, the system may inspect various zones in an acquired image of an environment near the acquiring device (e.g. camera). The zones are inspected to determine if there might be an image suitable for comparison to a reference database. In other words, the system inspects various zones of the immediate environment to determine if a person is present in the zone. If so, the system then attempts to determine if the person present matches any persons associated with reference images in a corresponding database. In one embodiment, the present invention is used to identify the presence of one of a small group of possible users of, for example, a home computer. Since the population of possible users is relatively small, such as four or five family members, the system can operate very quickly and perhaps with a more forgiving level of certainty than in more high security environments. This may be used to activate and present a customized desktop interface to the user, where the computer system presents different desktops to different users.

In one embodiment, an image is normalized before being analyzed. In one embodiment, an image is normalized with respect to size. In another embodiment, the image is normalized with respect to rotation. In yet another embodiment, the image is normalized with respect to horizontal and/or vertical position. In one embodiment, one or more reference locations are detected. The reference locations are used in the normalization process. In an example embodiment wherein the image is at least a partial image of a face, the eyes are located and used as the reference locations. In one embodiment, the center of the eye is used as a reference location. In another embodiment, the center of a portion of the eye (e.g., the pupil) is used as a reference location. In still another embodiment, another identifiable feature of an eye (e.g., an edge of the iris or eye white that is closest to the other eye) is used as a reference location. In one embodiment, when a desired reference location cannot be detected, an alternate reference location is selected. In one embodiment, the alternate reference location is a best-fit of the desired reference location. In an example embodiment, the desired reference location is an eye and the alternative reference location is the most eye-like location that can be detected in the image. In another embodiment, the alternate reference location is a location detected based upon a different set of search criteria from the originally desired reference location. In an example embodiment, the desired reference location is an eye and the alternative reference location is a nostril detected in the image.

In one embodiment, the image is normalized so that two reference locations are a specified distance from each other. In another embodiment, the image is normalized so that two reference locations are aligned consistent with a desired orientation. In still another embodiment, the image is normalized so that a reference location is in a desired location. In one embodiment, the normalized image is compared with another normalized image.

In one embodiment, one or more filters are applied to the image. In one embodiment, a filter is applied to convert the image to a monochromatic image. In another embodiment, a filter is applied to convert the image to a grey scale image. In still another embodiment, a filter is applied to normalize a luminance level of the image. In one embodiment, a filter determines a luminance value (e.g., the average luminance of the image) and determines a difference between the luminance value and that of each pixel in the image.

In one embodiment, a filter clips undesired portions of an image. In an example embodiment, the filter modifies an image of a face such that only the area between the outside points of the eyes and between the bottom of the eyebrow to the top of the upper lip remains unclipped. In another example embodiment, the filter modifies an image of a face such that only the forehead region remains unclipped. In another example embodiment, the filter modifies an image of a face such that only the chin region remains unclipped. In other embodiments, the filter modifies an image of a face such that other regions of the face remain unclipped.

In one embodiment, a filter removes locations where correlations between sets of points in unrelated images are not sufficiently likely to be random. In an example embodiment, a filter removes contours and/or edges of features (e.g., the contours of a nose, mouth, eye, hairline, lip, eyebrow, ear, or fingernail). Thus, in one embodiment, the image is filtered to result in an image of the skin of a body portion without edges caused by a skeletal, cartilagous, or muscular feature that are detectable beyond an edge-detecting threshold level.

In one embodiment, a filter is applied to only a portion of an image. In another embodiment, a filter is used to shift a portion of an image to a new location. In yet another embodiment, a filter is used to rotate a portion of an image. In one embodiment, a filter is used to undo the changes to an image that would be incurred by moving a portion of the image in accordance with making a gesture starting from the reference image. In another embodiment, a filter is applied to a reference image.

In one embodiment, the image is partitioned into blocks of pixels. In one embodiment, the pixel blocks are a contiguous rectangular region of the image. In other embodiments, pixel blocks are non-rectangular regions. In still other embodiments, pixel blocks are not contiguous. In one embodiment, a filter is applied to a block to distort the block into a different shape. In another embodiment, a filter is applied to a block to distort the block into a different size.

### BRIEF DESCRIPTION OF THE DRAWINGS

These and other features, aspects and advantages of the present invention will become better understood with regard to the following description, appended claims and accompanying drawings where:

FIG. 1 is a high-level schematic diagram of system components for a vision-based system.

FIG. 2 is a schematic diagram of components of a vision processing system.

FIG. 3 is a schematic diagram of additional components of the vision-based processing system of FIG. 2.

FIG. 4 is a schematic diagram of an alternative embodiment of a vision-based processing system.

FIG. 5 is a high-level flow diagram of the processes of a vision processing system employing a vision-based operating system.

FIG. 6 is a flow diagram displaying additional processes of a vision-based processing system.

FIG. 7 depicts a home environment in which a vision-based processing system may be used.

FIG. 8 depicts a transportation environment in which a vision-based processing system may be used.

FIG. 9 depicts a vehicle environment for a vision-based processing system.

FIG. 10 depicts a building environment for a vision-based processing system.

FIG. 11 depicts a computer environment for a vision-based processing system.

FIG. 12 depicts a secure storage environment for a vision-based processing system.

FIG. 13 depicts a venue environment for a vision-based processing system.

FIG. 14 is a flow diagram depicting high-level steps for use of a vision-based processing system to secure entry into a home.

FIG. 15 is a flow diagram depicting high-level steps for using a vision-based processing system to process images of gestures.

FIG. 16 is a flow diagram depicting steps for using a vision-based processing system to monitor an environment.

FIG. 17 is a flow diagram depicting steps for using a vision-based processing system for product recognition.

FIG. 18 is a flow diagram depicting steps for using a vision-based processing system to match an image of a face to a reference image.

FIG. 19 is a flow diagram depicting steps of an image filtering process of a face matching process of FIG. 18.

FIG. 20 depicts an image of a face prior to application of the filtering process depicted in FIG. 19.

FIG. 21 depicts an image of a face after application of the filtering process of FIG. 19.

FIG. 22 is a flow diagram depicting steps for comparing a face image to a reference image.

FIG. 23 depicts steps by which confirmation is obtained whether a face image matches a reference image.

FIG. 24 is a flow diagram of the process of analyzing an image in accordance with one embodiment of the present invention.

FIG. 25 is a flow diagram of the process of normalizing an image in accordance with one embodiment of the present invention.

FIG. 26 is a flow diagram of the process of normalizing an image when a desired reference location cannot be detected in accordance with one embodiment of the present invention.

FIG. 27 is a flow diagram of the process of normalizing an image when a desired reference location cannot be detected and an alternative search criterion is used to locate an alternative reference location in accordance with one embodiment of the present invention.

FIG. 28 is a flow diagram of the process of normalizing an image in accordance with one embodiment of the present invention.

FIG. 29 is a flow diagram of the process of analyzing an image in accordance with one embodiment of the present invention.

FIG. 30 is a flow diagram of the process of filtering an image to clip unwanted portions of the image in accordance with one embodiment of the present invention.

FIG. 31 is a flow diagram of the process of analyzing an image to detect specific changes between a reference image and an obtained image in accordance with one embodiment of the present invention.

FIG. 32 is a flow diagram of the process of filtering to remove regions associated with non-randomly occurring properties in accordance with one embodiment of the present invention.

FIG. 33 is a flow diagram of the process of analyzing an image when the image may represent an object viewed from a different orientation than that of a reference image of an object in accordance with one embodiment of the present invention.

FIG. 34 is a flow diagram of the process of probabilistic image analysis in accordance with one embodiment of the present invention.

FIG. 35 is a block diagram of a general purpose computer.

FIGS. 36A and 36B are block diagrams illustrating an environment switch system of the invention.

FIG. 37 is a flow diagram illustrating operation of the environment switch system.

FIG. 38 is a flow diagram illustrating operation of the environment switch system.

FIG. 39 is a flow diagram illustrating operation of the environment switch system.

FIG. 40 is a flow diagram illustrating operation of the environment switch system.

### DETAILED DESCRIPTION OF THE INVENTION

The invention is a method and apparatus for probabilistic image analysis. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Example System

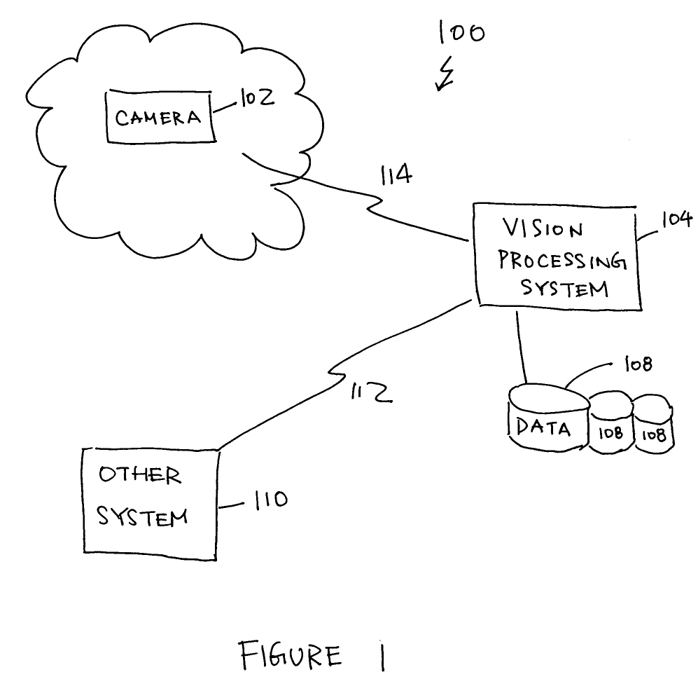

Referring to FIG. 1, a system 100 is provided, that is capable of being disposed in a wide variety of environments in accordance with various embodiments of the present system. The system 100 may comprise several different elements, including a camera 102, or similar image-capturing facility, and vision processing system 104. The system 100 may optionally include further elements, such as a data storage facility 108, and another computer-based device 110.

The camera 102 may be any device capable of capturing image data, such as a digital camera, a film camera, a video camera, a still-image camera, a movie camera, a beta recorder, a handheld camera, a fixed camera, a motion-sensing camera, or the like. The camera 102 may capture images in an environment and transmit the images to a vision processing system 104. In various embodiments, the images may be transmitted as digital data in the form of images comprising pixels. In other embodiments, the images may be taken by the camera in non-digital form and converted by the vision processing system 104 into digital form for processing. The camera 102 may be equipped with an interface, to permit its operation. The interface may be a direct user interface for use by a human user, such as a series of buttons or dials that allow the user to turn the camera on and off, to record image data, to position the lens, to change lens settings, to zoom in or out, to record, or the like. The interface may also be an interface that is accessed by or through another system, such as a computer. In one embodiment, the vision processing system 104 may access an interface of the camera 102 and control the camera 102.

The data storage facility 108 may be any suitable facility for storing data, such as RAM or ROM memory, a file, a Smart Media card, a diskette, a hard drive, a disk, a database, a zip drive, a data warehouse, a server, a mainframe computer, or other suitable facility for storing digital data. The data storage facility 108 may comprise an interface for allowing the vision processing system or a user to use the data storage facility to store, manipulate and retrieve data for any conventional purpose.

The vision processing system 104 is discussed in more detail below in accordance with various embodiments of the present invention. The vision processing system 104 may take image data from the camera 102 and take appropriate actions in response to those images. In various embodiments, the vision processing system 104 may also interact with the data storage facility 108 to store, manipulate or retrieve data. In other embodiments, the vision processing system 104 may also interact with the other device 110 or the camera 102. In some embodiments the vision processing system 104 may send control signals to the other device 110 or the camera 102, such as to activate or position the other device 110 or the camera 102. In other embodiments, the other device 102 or the camera 102 may send signals to the vision processing system 104, making possible interactive, or sensor-feedback loops, where the systems interact based on events or conditions in the environment, or based on user interaction with one or more of the systems.

In various embodiments a communication facility 114 may connect the camera 102 and the vision processing system 104. In other embodiments the camera 102 and the vision processing system 104 may be integrated in a single device. The communication facility 114 may be any suitable facility for transferring data, such as a cable, wire, network, wireless communication facility, Bluetooth facility, 802.11 facility, infrared, laser, fiber optic, radio, electromagnetic, acoustic, or other communication facility.

The other device 110 may be any other device capable of being put in communication with the vision processing system 104, such as via a second communication facility 112, which may be of any type mentioned in connection with the communication facility 114 discussed above. The other device 110 may be selected from a wide group of different possible devices, including, without limitation, an alarm system, a sound system, a sensor, an entertainment system, a video display system, a security system, a lock, a gate, a recording system, a measurement device, a medical device, a system for administering medicine, an appliance, an oven, a washing machine, a dryer, a stove, a dishwasher, a refrigerator, a freezer, a personal computer, a laptop computer, a PDA, a handheld computer, a server, a mainframe computer, a television, a client computer, a DVD player, a stereo system, a VCR, a compact disc player, a personal television recorder, a telephone, and a video phone. In embodiments, the vision processing system 204 may be integrated with or on board any one of these or any other processor-based device.

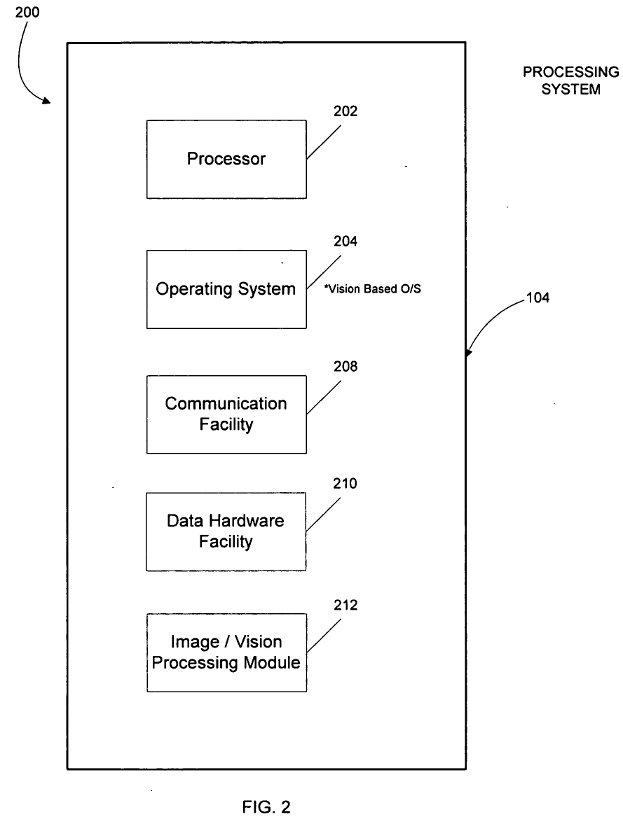

Referring to FIG. 2, a schematic diagram 200 shows an embodiment of components of a vision processing system 104. The vision processing system 104 may include various elements, such as a processor 202, a vision-based operating system 204, a communication facility 208, a data handling facility 210, and an image processing module 212.

The processor 202 may be any conventional facility for handling processing functions, such as a microprocessor, chip, integrated circuit, application specific integrated circuit, board, circuit, microcontroller, software, firmware, or combination of the above. In an embodiment, the processor 202 is a Pentium-based processor such as those used to operate personal computers.

The vision-based operating system 204, used in accordance with various embodiments of the present invention, is discussed in further detail below. In contrast to conventional operating systems that primarily respond to events that arise from keypad, mouse, clock, or similar events, the vision-based operating system is configured to take inputs in the form of images, either in lieu of or in addition to other events that can serve as inputs to conventional operating systems. Thus, the vision-based operating system is equipped with a facility for handling images that are digitized into pixels and taking actions in response to the content of the images.

The communication facility 208 may be any suitable facility for enabling the vision processing system 204 to communicate or interact with other systems or devices that are external to the vision processing system 204. Thus, it may include hardware (e.g., a modem, DSL modem, connector, bus, port, serial port, USB port, network card or the like), software (communications software, network software, or the like), firmware, or a combination of these.

The data handling facility 210 may comprise hardware elements, such as RAM, ROM, a hard disk, a memory card, a smartmedia card, of other similar data handling facilty, as well as software elements such as database software or other software for handling any data-related tasks that the operating system 204 may require for interacting with the data storage facility 108.

The image processing module 212 may comprise hardware, software, firmware, or a combination of them for processing images, including facilities for executing various algorithms and sub-processes under control of the vision-based operating system 204, to store, manipulate, retrieve and otherwise take actions on, or in response to, digital images that serve as inputs to the image processing module 212. The image processing module 212 takes images as inputs and outputs any of a variety of signals, including instructions to the vision-based operating system, instructions for storing, manipulating or retrieving data, messages or other communications for the communications facilities 112, 114, images, text, sounds, or other signals. Functions of the image processing module 212 in one embodiment are discussed further below.

Further Details of Vision-Based System of Various Embodiments

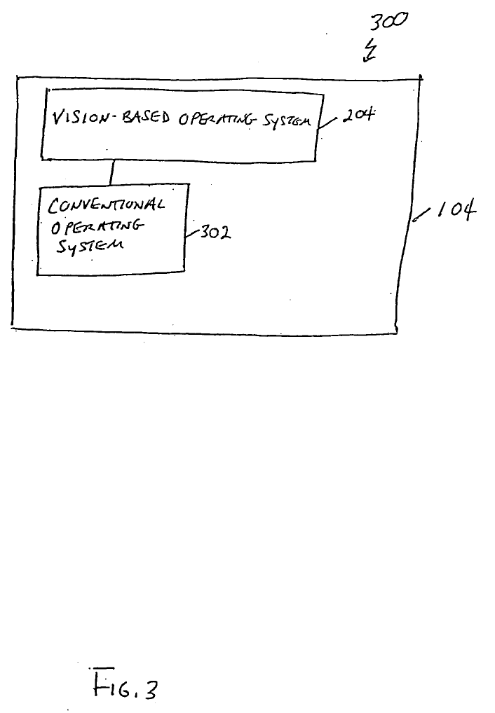

Referring to FIG. 3, a further detail of an embodiment of the vision-based operating system 204 is displayed in a schematic diagram 300. In this embodiment, the vision-based operating system 204 serves as the primary operating system of the vision processing system 104, so that the primary inputs of the vision processing system 104 from its environment are images or other vision-based data. The vision-based operating system 204 may optionally control a subsidiary operating system, which may be a conventional operating system 302, that responds to signals from the vision-based operating system 204. The conventional system may be a Windows, MAC, Unix, Linux, or other conventional operating system such as may exist or be developed in the future for taking actions in response to events or conditions in the vision processing system 104. Thus, for example, the vision-based operating system may initiate events that are picked up by a loop running in the Windows operating system, to control other aspects of the vision processing system 104, or to send signals elsewhere, either internally or externally.

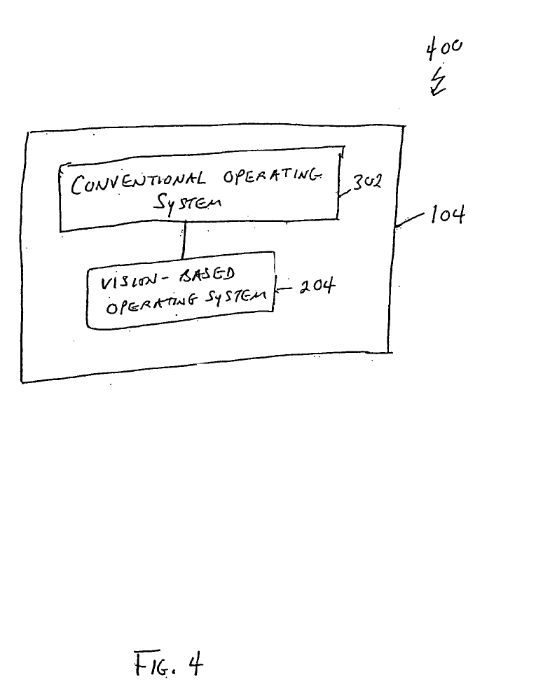

Referring to FIG. 4, as depicted in a schematic diagram 400, in another embodiment the roles of the vision-based operating system 204 and the conventional operating system 302 may be reversed relative to the configuration of FIG. 3. In the embodiment of FIG. 4, the conventional operating system 302 controls the vision-based operating system, which operates as a sub-system. In this system, the conventional operating system may recognize certain inputs or events as comprising images or other vision-based data and may hand those inputs off to the vision-based processing system 204. The conventional operating system 302 may respond to outputs from the vision-based processing system that are in the form of suitable events or signals, such as Windows events. Thus, the conventional operating system 302 may control the vision processing system 104, aided by the facility of the vision-based operating system for handling images as inputs. In one embodiment, image input is fed to a conventional operating system without use of a vision-based operating system.

Image Processing

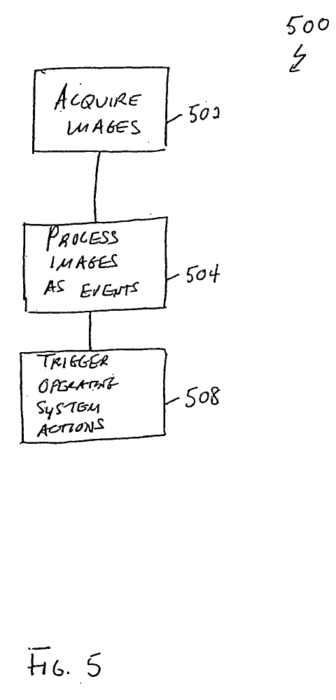

Referring to FIG. 5, a flow diagram 500 displays the high-level processes of a vision processing system 104 employing a vision-based operating system 204. At a step 502, the vision processing system 104 acquires images or image-based data. At a step 504 the vision-based operating system 204 or the image processing module 212 converts the image data into a signal that signals an event associated with the image that was input to the system. At a step 508 the vision-based processor 204 takes an action based on the vent that is associated with the image at the preceding step.

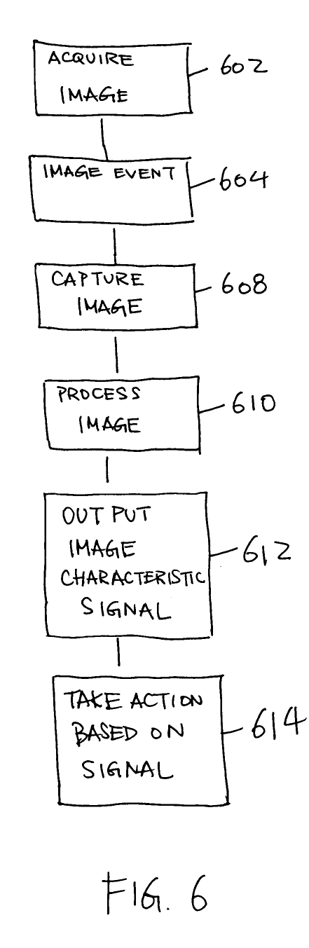

Referring to FIG. 6, a flow diagram 600 displays further processes that can be accomplished by a system 100 as disclosed herein. At a step 602, the system 100 may dispose a facility in an environment for acquiring an image, such as the camera 102. At a step 604, an image event may occur in the environment. The event may be a motion, or it may be the presence of an image having particular characteristics, such as a face or body part, or other meaningful image. The event may also be the presence of any sort of symbol in the image, such as a letter, number, word, sign or other symbol. The event may also be the absence of something from the image, such as the absence of a normally present item from the image, or the absence of motion from an image where motion is expected. Image events that can be recognized at the step 604 are without limit, and certain image events that are processed in various embodiments are discussed further below. Once an image event occurs at the step 604, at a step 608 it may be captured by the camera 102.

Next, at a step 610 the image may be processed by the image processing module 212 under control of the vision-based operating system 204. At a step 612, the vision processing system 204 may output a signal that reflects an image characteristic, as determined by the processing step 610. The output signal at the step 612 may take any form, such as an event for handling by a conventional operating system 302, a signal for controlling another device 112, a signal for controlling the camera 102, another image for further handling by the image processing module 112, or other signal or image that reflects a characteristic of the image captured at the step 608. Certain embodiments of the processing step 610 are further described below. At a step 614, the system 100 may take an action based on the content of the signal that is established at the step 612.

Image events that may be processed at the step 604 may include positioning of a face in front of the camera 102, detecting motion, changing the content of the image, detecting a face in an image in a particular location, such as in a window, detecting images of a person speaking, images of body parts, such as lips, hands, or legs, images of gestures with the head, hands, fingers, or other body parts, facial features, symbols, letters, words, numbers, signs, or other images that have the potential to have contact that is meaningful for purposes of using the vision processing system 104.

At the processing step 610, a wide range of image characteristics may be analyzed. For example, the processing step 610 may determine what an object in the image is, such as whether it is a face, a person, a body part, a symbol, a sign, or other feature. Similarly, the processing step 610 may match an object in the image to another object of another image, such as matching a face image to an image of a reference face. The processing step 610 may also match another object, such as a code, to a code in a reference image. Matching may occur between codes, gestures, faces, body parts, biometric measurements, motions, signs, symbols, or other features for a variety of purpose, with the output signal at the step 612 reflecting whether or not a match occurred. The processing step may also process a characteristic of the structure of an environment, such as the presence or absence of an item in an expected place, such as a valuable item in a room that is monitored by the camera 102, or the physical condition of an item, such as a window, roof, or door, to ensure that is has not been damaged. The processing step 610 may also process characteristics of a face, such as emotions reflected by particular facial movements or positions. The processing step 610 may also process whether movement is occurring in the environment and output a signal to reflect whether any movement, or a particular movement, is occurring, such as for monitoring for movement in a secure environment, or monitoring for movement of a patient in a medical environment to ensure that the patient is occasionally moving. The processing step 610 may also process the image to determine whether any new item has appeared in the environment, and may analyze the new item to determine its nature. At the processing step 610 the system 100 may identify particular environmental features, such as smoke, fire, moisture clouds, water, or other image features that suggest that a message or alarm should be sent from the system. In embodiments, the processing step 610 may process images of children, pets, or other entities in the image and take actions based on the nature of the movements, such as proximity of a child to a dangerous item such as a stove or unmonitored swimming pool. In embodiments the processing step 610 may take actions based on a combination of any of the above or other image characteristics or events, or a combination of one or more of them with input from another device or system, such as input of a manual security code on a keypad, in combination with matching a face to a reference image for security purposes. These embodiments of a processing step 610 should be understood to be representative of the many different image characteristics that can be processed for purposes of identifying and taking further action, all of which should be understood to be encompassed in the present disclosure.

Many different types of actions can be taken at the action step 614. Examples include sending a message or other communication, turning an device or system on or off, initiating action of another device, inducing motion of or otherwise controlling in any manner the vision processing system 104, camera 102, or other device 112, allowing entry into a secure environment, opening a lock, sending an “all clear” signal, and preventing entry into an environment. Of course the action step 614 may initiate any action that can be taken by any other device 112, so the types and nature of the actions are potentially limitless.

Environments for Vision-Based Processing

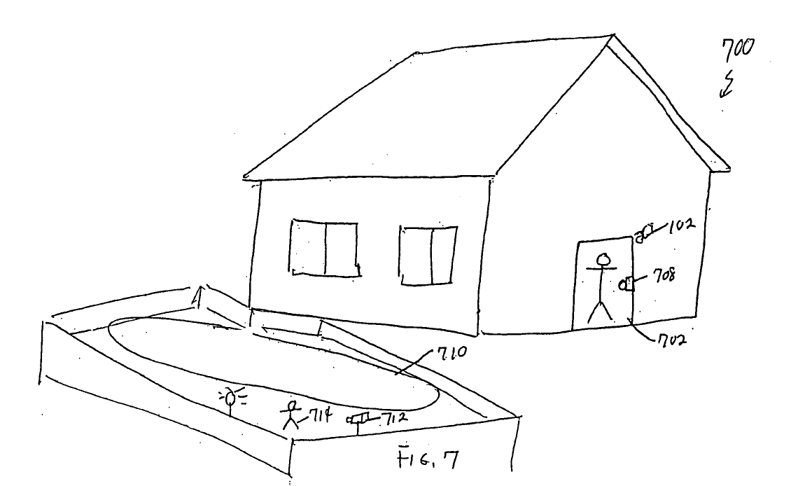

There are many potential environments in which a vision-based processing system may be used. Referring to FIG. 7, one such environment is a home 700. Many home uses are possible. In one such use, a camera 102 may be disposed at the door 702 of the home 700, where a user 704, such as a resident of the home, may look into the camera 102 for facial recognition purposes (as described in greater detail below). The camera 102 may have an onboard vision processing system, or may be connected to a separate vision processing system 204, for determining whether an image of the user's face matches one or more reference face images stored in the data storage facility 108. If there is a match, then a lock 708 on the door 702 may release, allowing entry. In another embodiment, the home 700 may have a swimming pool 710, at which a pool camera 712 may be disposed for monitoring the pool environment. The pool camera 712 may capture an image of a child 714 and, via a vision processing system 104, trigger an alarm 718 if the child 714 comes in too close proximity to the pool 710. Such a combination of camera and alarm could be used to alert a parent or other adult to the proximity of a child or pet to any dangerous object, such as a stove, oven, fireplace, wood stove, work bench, or the like, or to breakable items, such as china, crystal, vases, or other valuables.

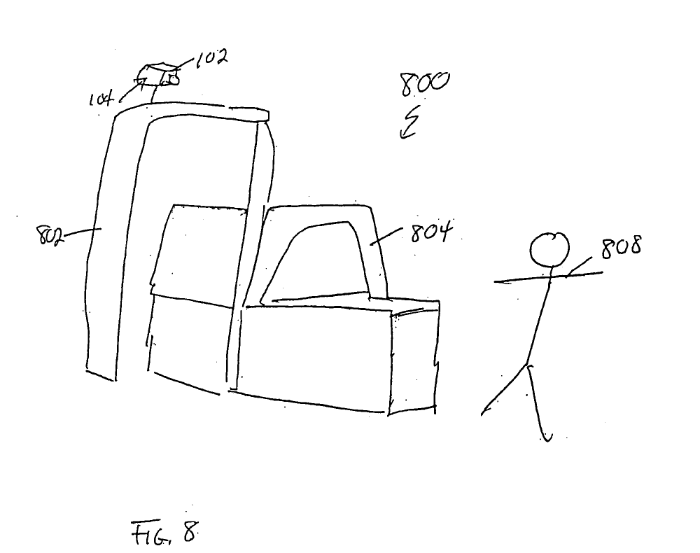

Referring to FIG. 8, another environment in which a vision processing system 104 and camera 102 may be disposed is a transportation environment, such as an airline terminal security environment 800. The environment may include a metal detector 802, as well as an article-screening device 804, in both cases one of various conventional types of such devices used by airlines to screen passengers and their articles. In the environment 800 the camera 102 may capture an image of a passenger 808 and match the passenger's face image against a reference image, to confirm the identity of the passenger as a security measure. A similar system can be disposed in other transportation security environments, such as those in bus, rail and ship terminals, as well as on transportation vehicles, such as cars, buses, trucks, planes, trains, ships, boats, and the like. In one embodiment, the transportation environment may be a parking lot, and a system 100 with a camera 102 and vision processor 104 may be used to monitor images of a vehicle to ensure that it is not moved or damaged. If the image of the vehicle is altered during a predetermined period, then the system 100 may sound an alarm or send an alert, such as to the owner of the vehicle or to a security guard. The system 100 may be further equipped with a facility for recognizing the face of the owner or operator of the vehicle, so that person can enter and move the vehicle without triggering an alarm or alert. The system 100 may also be used to monitor use of a reserved parking place, so that if the face of a person parking in the spot does not match a reference image, a message is sent to the operator of the parking facility that unauthorized use of a reserved spot may be taking place.

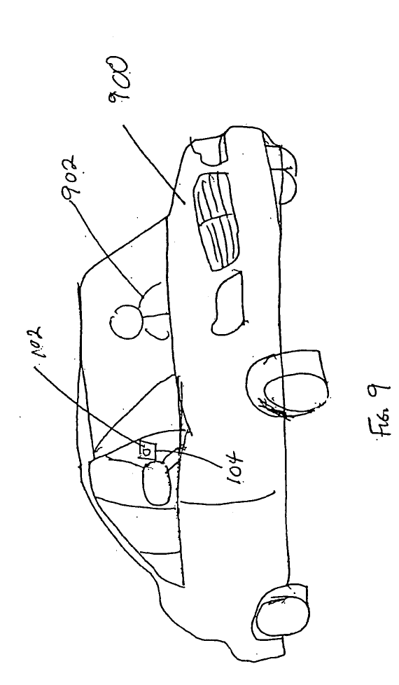

Referring to FIG. 9, another environment in which a vision processing system 104 and camera 102 may advantageously function is a vehicle, such as a car 900. The camera 102 can take an image of the face of a driver 902 and match an image against a reference database to confirm that the driver 902 is authorized to drive the car. The reference database might store data to confirm that the driver is the owner of the car, that the driver is a licensed driver, that the driver does not have moving violations or the like that restrict driving, that the driver is the person who has rented the vehicle, or the like. The vision processing system 104, upon determining a match, can take various actions, such as unlocking or locking the doors, allowing or preventing the starting of the engine, or allowing or preventing operation of other vehicle systems. Although a car 900 is shown in FIG. 9, other vehicles can use similar systems, such as boats, trucks, minivans, taxis, buses, ships, planes, jets, scooters, motorcycles, or the like.

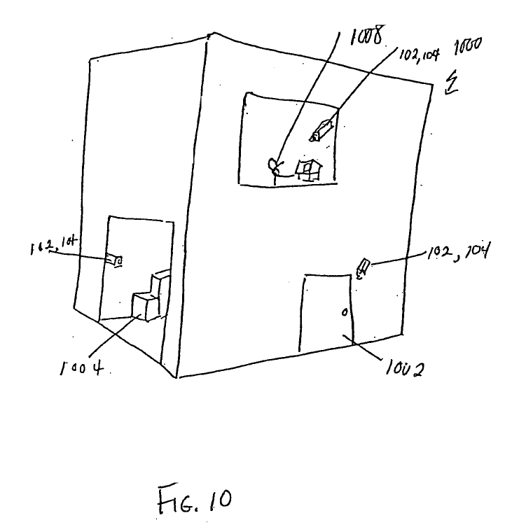

Referring to FIG. 10, another environment is a building 1000, such as an office building, workplace, or similar environment. As with a home, a camera 102 and vision processing system 104 may be used to provide security access at a door 1002 at the exterior or interior of the building 1000. Similarly, a camera 102 and vision processor 104 may be used to monitor one or more items in the building 1000, such as to prevent their being stolen, or to monitor their location within the building. For example, the vision processing system 104 may determine the location of items of inventory in a warehouse based on their image shapes, or based on codes or images, such as brands or logos, located on the items. The vision processing system 104 can then interact with another computer system, such as an inventory control system. In another embodiment, a camera 102 and vision processing system 104 can be used to monitor actions of a person 1008, such as for security purposes to ensure that the person is conscious and has not been harmed, or for other purposes, such as to determine whether or not certain actions have occurred, perhaps as a precondition to taking a further action. For example, the system 100 could determine when an item whose image is matched to a reference image in a database has arrived from a pre-processing location to a location for further processing and then send a message to the user 1008 that the item is ready. Many other workplace uses of a vision-based processor 204 in a vision processing system 104 can be envisioned and should be understood to be encompassed herein.

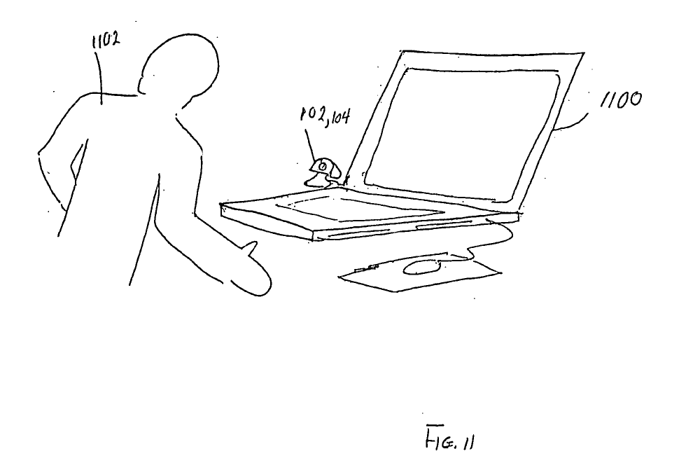

Referring to FIG. 11, a camera 102 and vision processing system 104 may be used in an environment that contains a computer 1100, such as a personal computer, laptop computer, personal digital assistant, handheld computer, or the like. The camera 102 may capture images in the environment of the computer 1100, such as images of a user 1102. The vision processing system 104, which may be on board the camera 102, the computer 1100, or another computer system that is external to both, can process images taken by the camera 102, such as images of the user 1100. For example, the vision processing system 104 may match the face of the user 1102 against a set of reference images to confirm the identity of the user 1102. Thus, the system can be used for security purposes in lieu of or in addition to other security measures, such as passwords. In an embodiment, the computer 1100 may be used by the user 1102 to interact with a site, such as an Internet site, such as for e-commerce, game, research, or entertainment purposes. In an e-commerce use, the user 1102 may use the vision processing system 104 to confirm the user's identity, to ensure the security of an e-commerce transaction, such as use of a credit card to purchase goods or services online.

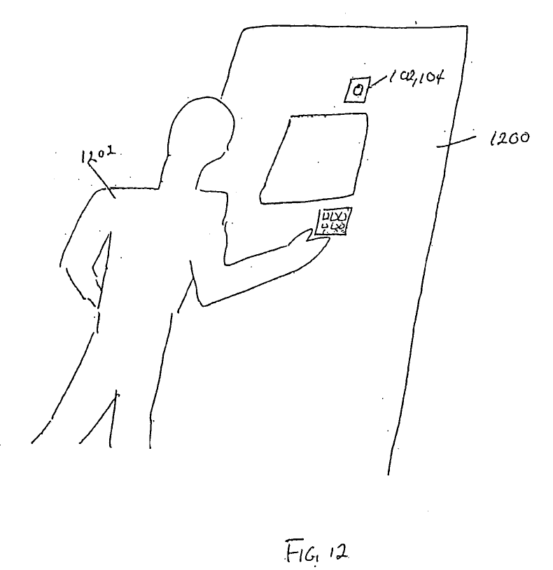

Referring to FIG. 12, in another embodiment the camera 102 and vision processing system 104 of a system 100 may be disposed in an environment that provides secure storage, such as for cash or other valuables, such as an automated teller machine (ATM) 1200. The system 100 can then be used to verify the identify of a user 1202 before permitting a transaction, such as withdrawal of cash, checking an account balance, or making a transfer from an account. Similarly, the system 100 can be used to provide identity verification for safe deposit withdrawals, withdrawal of valuables from a safe, or removal of items from a locked storage facility of any size. In embodiments, the system 100 may provide both an identity verification function and a separate function, such as monitoring images of items that are secured in the facility to ensure that they have not been removed, moved, or damaged.

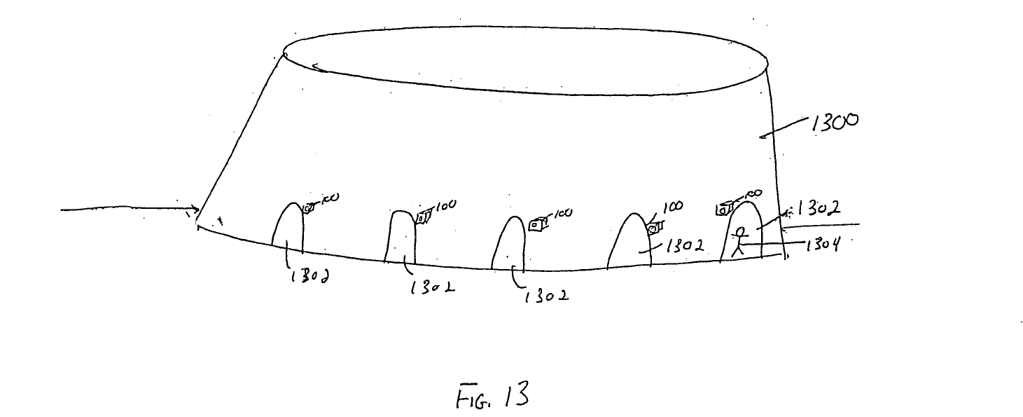

Referring to FIG. 13, a system 100 comprising a camera 102 and vision processing system 104 can also be disposed in an environment that includes a venue 1300 that includes a gate 1302 or similar facility for restricting access to the venue 1300. The venue 1300 may have a central computer system, or computing functions may be included at the gate with each system 100. The system 100 may access a reference database of images for the purpose of matching an image taken by the camera 102, to ensure that a user 1304 seeking access to the venue 1300 is an authorized user, such as confirming that the user 1304 bought a ticket to an event at the venue, or the user 1304 is an employee or authorized contractor entitled to enter the venue. Many different venues can be envisioned, such as sporting event venues, such as football, basketball, soccer, hockey, baseball, and golf venues, performance venues, such as movie theatres, playhouses, event centers, concert venues, and opera houses, accommodation venues, such as hotels, motels, casinos, bars, convention centers, and restaurants, and many others.

Vision-Based Entry Security

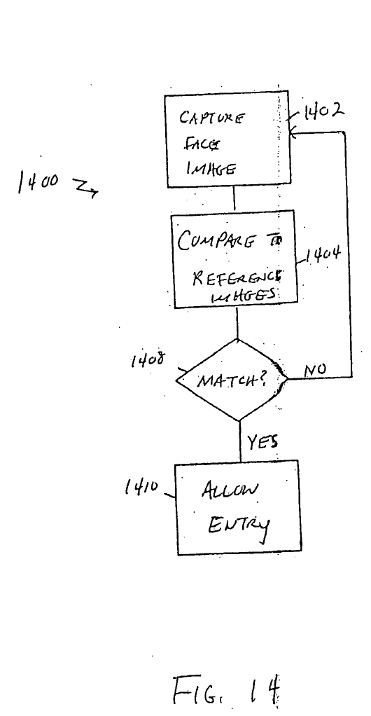

Referring to FIG. 14, a flow diagram 1400 shows high-level steps for an embodiment of the invention where a system 100 is used to secure entry into an environment such as a home. At a step 1402 the system 100 can capture an image of a face (or other identifiable characteristic) of the user. Next, at a step 1404 the system can compare the image to one or more reference images stored in a data facility. Next, at a step 1408 the system can determine whether the images match (as described in much greater detail below). If not, then the system can try again by returning to the image capture step 1402. If there is a match, then at a step 1410 the system can allow entry into the environment.

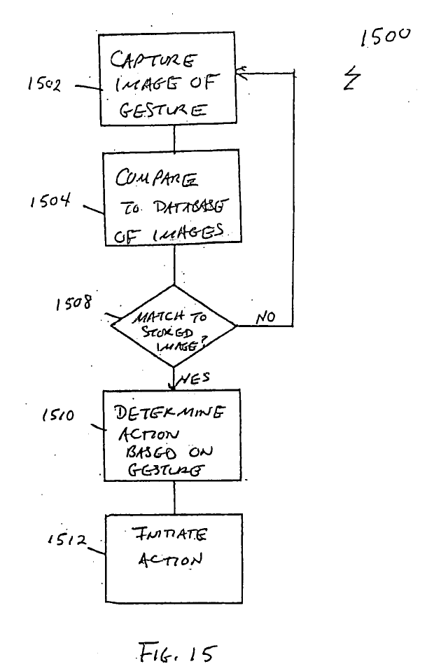

Referring to FIG. 15, a flow diagram 1500 shows steps for an embodiment of the invention in which a vision processing system 104 processes images from a camera 102 for purposes of identifying and acting on gestures that are capture in the images. At a step 1502, the camera 102 captures an image that potentially includes a gesture and relays it to the vision processing system 104. At a step 1504 the image processing module 112 of the vision processing system 104 compares the captured image to a database of images of gestures to determine whether the captured image contains a gesture that matches a stored gesture. Next, at a step 1508, the image processing module 112 determines whether a match has occurred. If not, then processing returns to the step 1502 for further capturing of images. If there is a match at the step 1508, then at a step 1510 the system determines what gesture has been matched, and what action is appropriate, by reference to stored rules that relate each gesture or series of gestures to related actions. Next, at a step 1510, the system initiates an action based on the identified gesture. In some cases, the action may be to wait for a further gesture, so that the system can act based on combinations of gestures, as well as upon single gestures. By way of example, the system could monitor a patient and trigger a query asking if the patient is ok. If the patient gestures with a “thumbs up” gesture, then the system can send a message to a care provider that the patient is ok. Similarly, the system can capture a gesture, such as waving hands, to indicate that an alarm or alert should be triggered. By creating a complete set of rules, it is possible for a vision processing system 104 to initiate any actions that would otherwise be triggered by keypad, mouse, or voice entry. Thus, the vision processing system 104 can, through gesture control, replace or supplement a conventional computer operating system.

Vision-Based Action Triggering

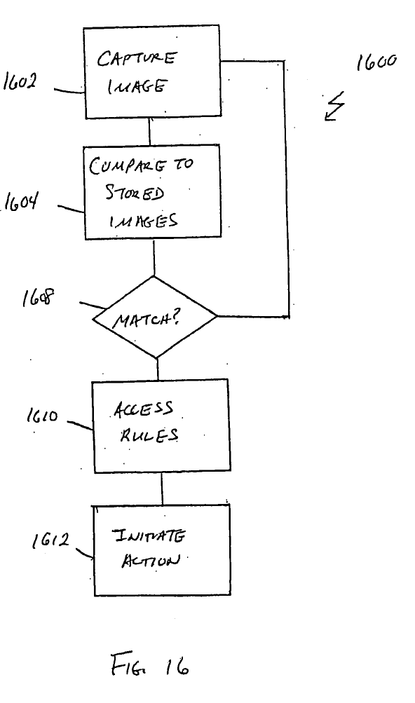

Referring to FIG. 16, a flow diagram 1600 indicates high-level steps for using a system 100 to monitor an environment in order to trigger an appropriate action. At a step 1602, the system captures an image of the environment. Next, at a step 1604, the system compares the image that was captured to a database of reference images to determine whether a match occurs. If, at a step 1608 a match does not occur, processing returns to the step 1602 for further image capture. If a match occurs at the step 1608, then the system can, at a step 1610, access a plurality of rules that determine what action should be taken in response to the identification of the image. Then, a step 1612, the system can initiate an action based on the rules. Examples of images that can be matched include images that show motion, images that show proximity of motion to a particular item, images that have unique characteristics, such as smoke, fire, or water, images that show proximity of two items to each other (such as for prevention of collisions), absence of motion, and the like. When one of these items is matched, the rules can then determine the action. For example, if smoke, fire, or water is detected where it is abnormal, then an alarm or message may be sent to an operator or to an emergency service. If two items (such as two boats) are coming in too close proximity, then an alarm can be sounded to an operator. If a child is too close to pool or stove, then an alarm can be sounded and a message sent to a parent. If an item is missing from an image, then an alert can be sent to a security guard or other person responsible for monitoring the item. Thus, by matching images and triggering rules, the system can provide monitoring of any environment for a wide range of purposes.

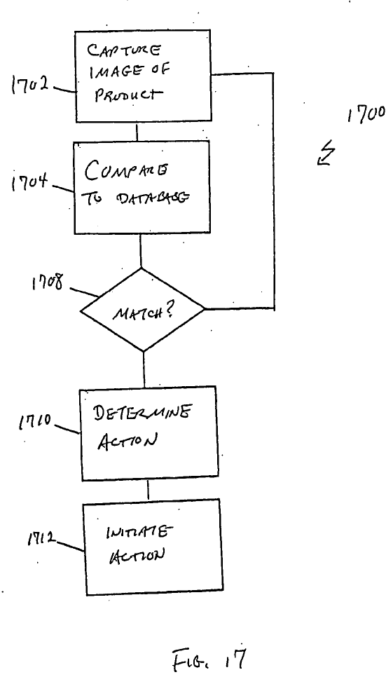

Referring to FIG. 17, a flow diagram 1700 shows the high-level steps for use of the invention in an embodiment used for product recognition. At a step 1702 the camera 102 may be used to capture an image of a product, such as in a warehouse for inventory control purposes or at a retail counter, for pricing purposes. Then at a step 1704 the image of the product can be compared to images stored in a data facility. At a step 1708 the system can determine whether a match has occurred. If not, then the system can return to the step 1702 and continue attempting to find a match. If so, then at a step 1710 the system can determine the nature of the product of which an image was captured and consult a set of rules that are stored for that product to determine an action. For example, the system can determine that the item is a box of a particular brand of cereal, and it can retrieve the price of that box of cereal pursuant to the rules for retrieving prices. Next, at a step 1712 the system can initiate an action based on the determination of the image, such as charging the price for the box of cereal, or storing an indication that a particular item is in a particular location.

Environment Switch

The present invention includes an embodiment referred to as an environment switch. The environment switch is a recognition system that can be used, for example, in connection with a personal computer to provide a custom desktop automatically when the owner of the desktop is in front of the computer. Many current operating systems for personal computers permit the creation of custom desktops environments by multiple users of the computer. The different environments or desktops can be protected via password to prevent their use. This is particularly helpful when children and adults use the same computer. This scheme allows parents, for example, to set up environments for children that limit their permission to use certain programs or access certain websites. In a business environment, it permits colleagues to share a computer while still maintaining privacy.

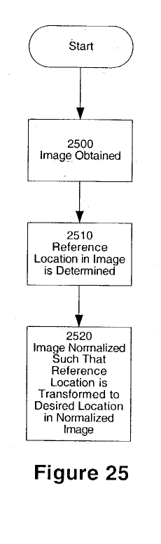

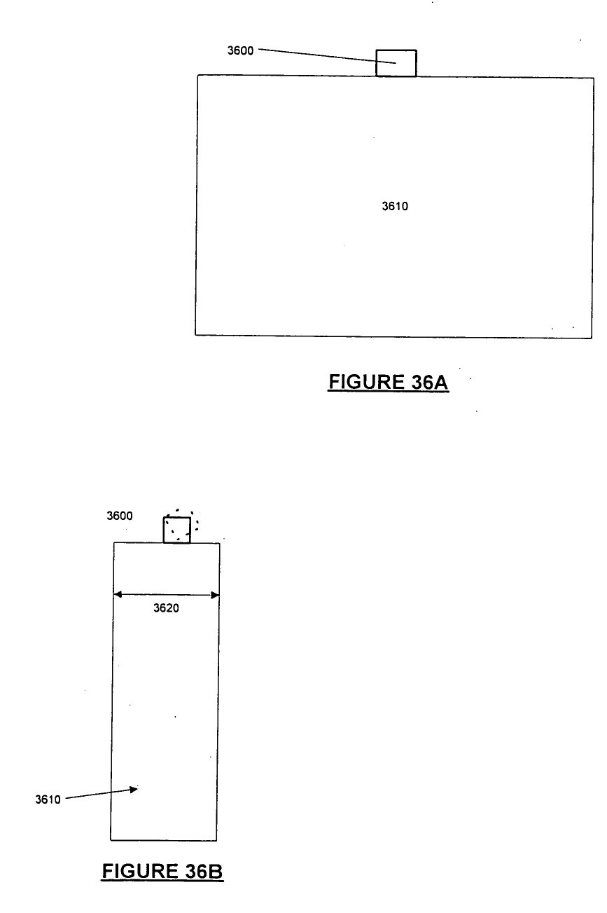

In one embodiment, the environment switch includes a camera that can be attached to the top of a computer monitor facing in the direction of the monitor screen. In other words, if the screen is analogous to a camera lens, then the camera of the environment switch will see everything seen by the screen. This means that the environment switch system has a zone of vision, which is limited to what it would see depending on the angle of its attachment to the top of the screen. FIG. 36 illustrates a front (FIG. 36A) and a side view (FIG. 36B) of a camera of an environment switch system attached to the top of a computer monitor. FIG. 36A shows camera 3600 attached to the top of monitor 3610. Since the top of the monitor has a varying depth depending on the monitor model and make, the camera can be attached not only anywhere between the left and right extremes of the monitor, but also anywhere within the depth of the top. FIG. 25B illustrates varying depth indicated by distance 3620. FIG. 36B also illustrates the camera's zone of vision indicated by angular distance 3630. When the angle of the camera is changed by a user, the zone of vision changes accordingly. FIG. 36B also shows a different angle of switch 3600 and the corresponding zone of vision 3640 indicative by dotted lines.

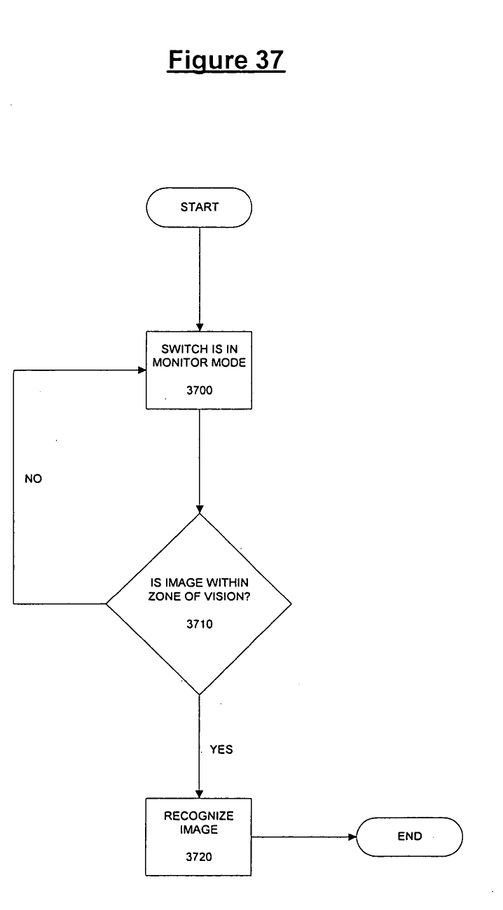

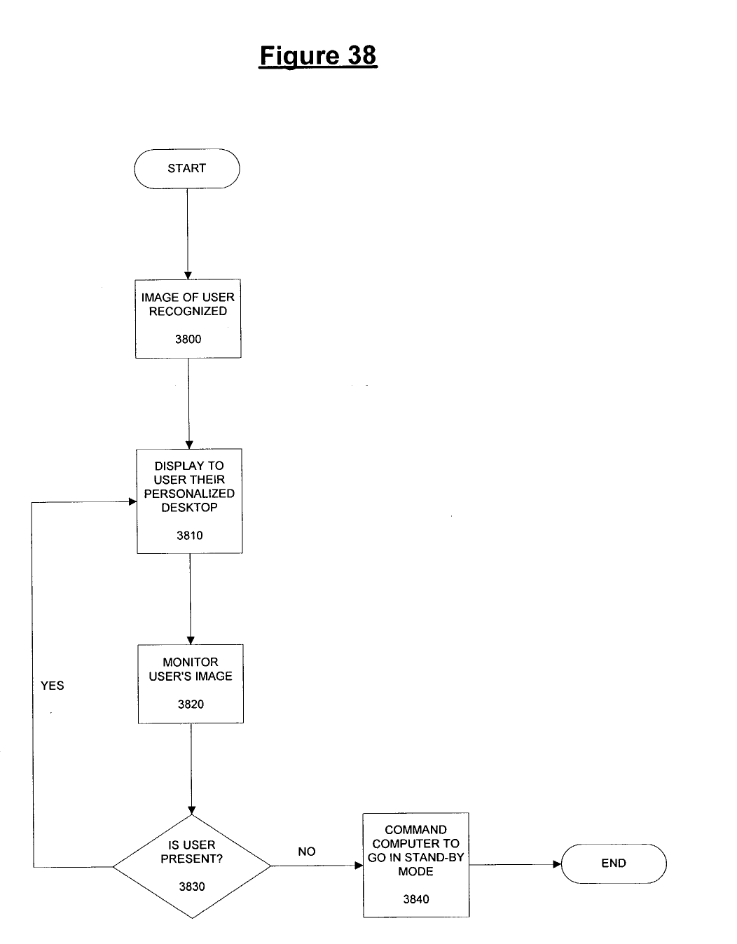

According to one embodiment of the present invention, the image to be recognized has to be within the zone of vision of the camera. FIG. 37 illustrates a flowchart where at step 3700 the camera is in monitor mode. In other words, the camera is ready to recognize any image within its zone of vision. At step 3710, a check is made to see if an image is within the zone. If the image is not within the zone (the “no” branch), then the switch continues to monitor for an image. If, on the other hand, the image is within the zone (the “yes” branch), the image is recognized at step 3720.

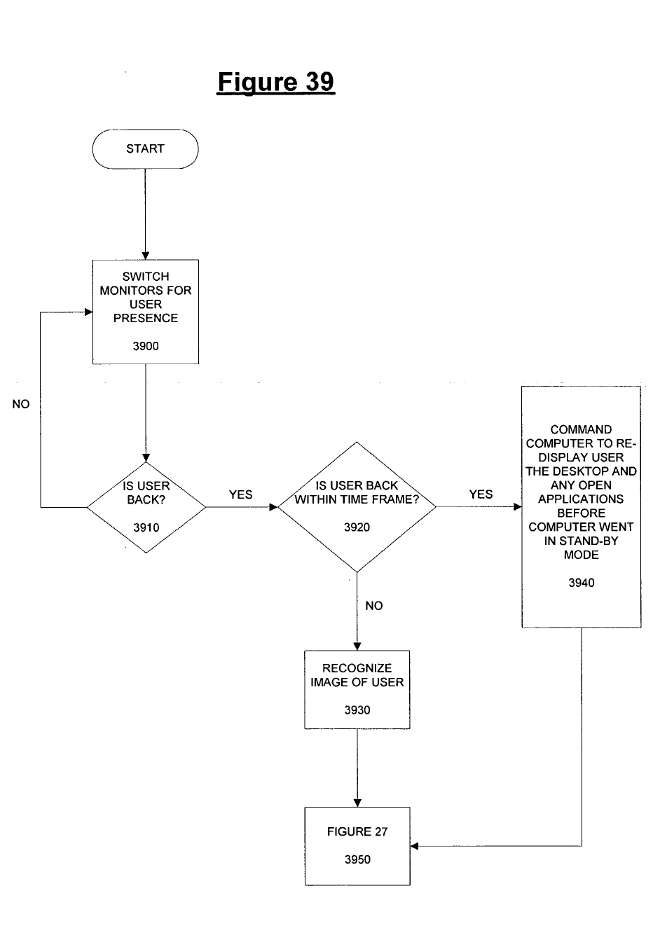

According to another embodiment of the present invention, once the image of a user (user A) is recognized, the camera sends a command to the computer to display on the monitor the personalized desktop of user A, or other programs selected by user A. FIG. 38 illustrates a flowchart where at step 3800, the image of a user (user A) is recognized. At step 3810, a command is send to the computer to display on the monitor the personalized desktop settings of user A. At step 3820, the system monitors the presence of user A. At step 3830, a check is made at fixed intervals to see if user A is still within the zone of vision. In other words, the environment switch system checks at fixed intervals to see if the user is still present in front of the monitor. The physical presence of the user is one way to monitor the user. Another way to monitor the user would be to monitor the time between keystrokes or mouse clicks. If user A is still present within the zone of vision (the “yes” branch), the system continues to command the computer to display the personalized desktop or other programs to user A. If, on the other hand, user A has stepped outside the zone of vision (the “no” branch), then at step 3840 the system commands the computer to shut down and go in stand-by mode or sleep mode. In the stand-by or sleep mode, the entire computer is not shut down, but rather is in a mode analogous to a screensaver mode where the desktop along with any open programs is hidden from the user when the user does not move the mouse or strikes a keystroke for a certain length of time.

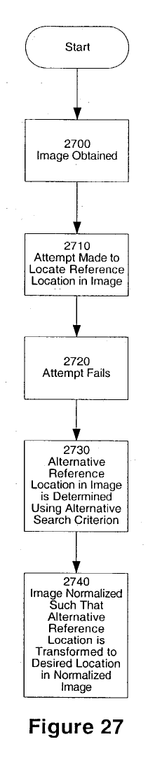

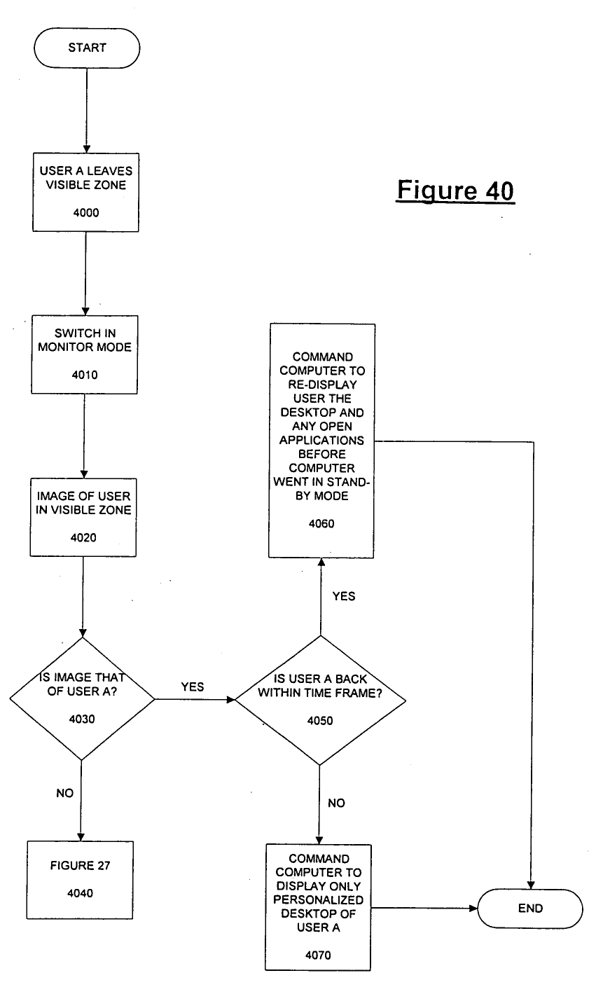

According to another embodiment of the present invention, the system commands the computer to re-display the desktop along with any open programs and applications to the user (user A), if the user's presence is monitored before the end of a certain time frame once the computer goes in stand-by mode. FIG. 39 illustrates a flowchart, where at step 3900 the system monitors for user A's presence. At step 3910 a check is made to see if user A is back within the visible zone. If user A is not back (the “no” branch), then the system continues to monitor for user A's presence. If, on the other hand, user A is back within the visible zone (the “yes” branch), then another check is made at step 3920 to see if user A is within a certain time frame. If user A is not back within a certain time frame (the “no” branch), then at step 3930 the image of user A is recognized and all the steps of FIG. 27 are repeated at step 3950. If, on the other hand, user A is back within the certain time frame, then at step 3940 (the “yes” branch) the system commands the computer to redisplay to user A desktop and any open applications before the computer went in stand-by mode.

There could be a situation where instead of user A (who was currently using the computer before it went into stand-by mode), another user (user B) comes within the visible zone. According to another embodiment of the present invention, the system is capable of holding in its database images of more than one user (and hence more than one set of personalized desktops). FIG. 40 is a flowchart that illustrates at step 4000 user A leaving the visible zone. At step 4010, the system is in monitor mode. At step 4020, an image of a user is seen within the visible zone. At step 4030 a check is made to see if image is that of user A. If the image is not of user A (the “no” branch), it means that another user (user B) is within the visible zone, and all the steps of FIG. 38 are repeated at step 4040. If, on the other hand, the image is that of user A (the “yes” branch), then at step 4050 a check is made to see if user A is back within a certain time frame. If user A is back within the time frame (the “yes” branch), then at step 4060, the system commands the computer to re-display to user A all the applications that were open before user A left the visible zone. If, on the other hand, user A is not back within a certain time frame (the “no” branch), the system, at step 4070, commands the computer to display the personalized desktop of user A.

The environment switch system of the invention can use all of the embodiments of image analysis described herein to determine if a match has taken place. Because in many home environments there are only a few users, e.g. four or five, it may be possible to use a simpler image analysis system to provide user identification. In a system where it is possible to modify parameters to control the level of certainty of the image matching, the parameters can be set to a lower level of certainty if desired while still allowing desired performance in changing environments.

Image Recognition

Further details will now be provided as to a system for matching a face to confirm the identity of a user of the system 100, such as for allowing entry into a home via a home security system. As depicted in FIG. 7, a system 100 can be used at a door 702 or entryway to control access via a lock 708 or similar mechanism into a home 700. As depicted in the flow diagram 1400 of FIG. 14, the system can be used to match a face against one or more reference images in a data facility. As in FIG. 1, a face matching system may have similar components to a more general vision processing system 100, such as a camera 102, a vision processing system 104, a data facility 108, and an optional other system 100, such as a system for electronically opening a lock.

In one embodiment of the invention, a comparison is made between a patch of skin of a target person to be identified and a corresponding reference image of a patch of skin from a database of reference images. An analysis is performed to determine if the target person is a member of the population of the members of the database. The use of a patch of skin has shown to be highly accurate and results in almost no false positives and minimal false negatives. The comparison of the patches of skin is based on selected attributes of the patch that can be quantized and compared.

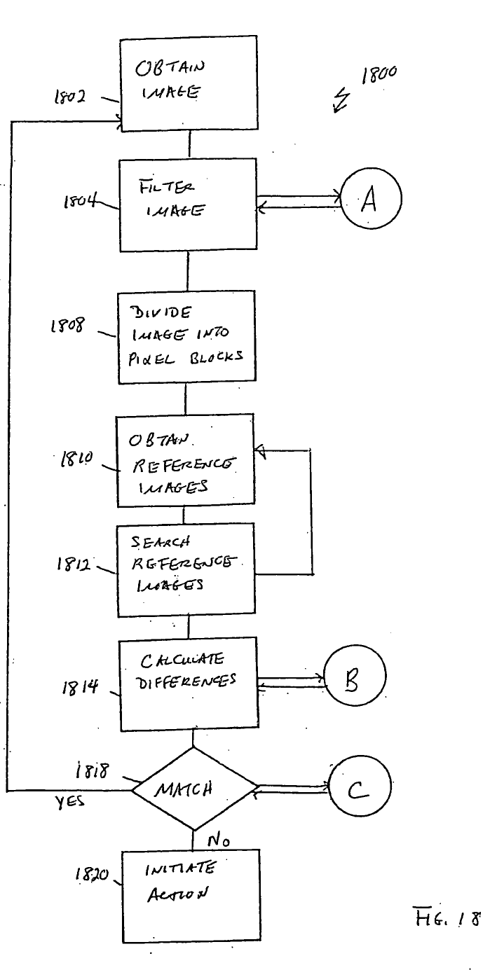

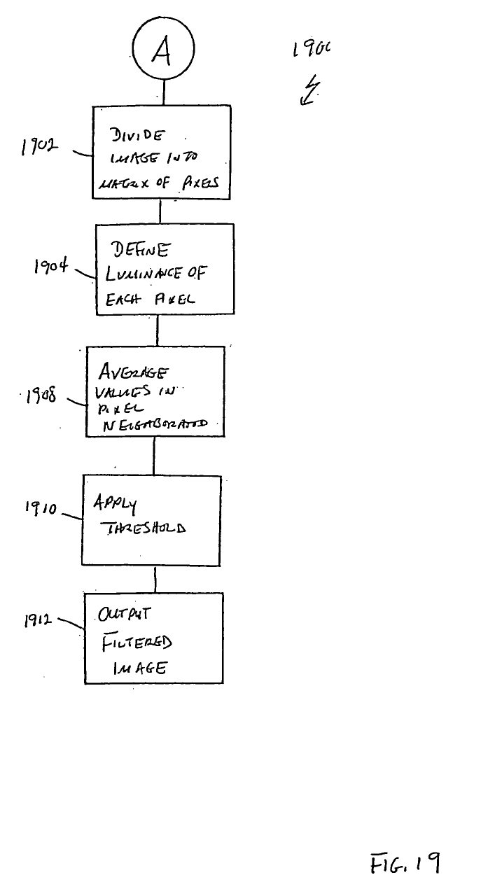

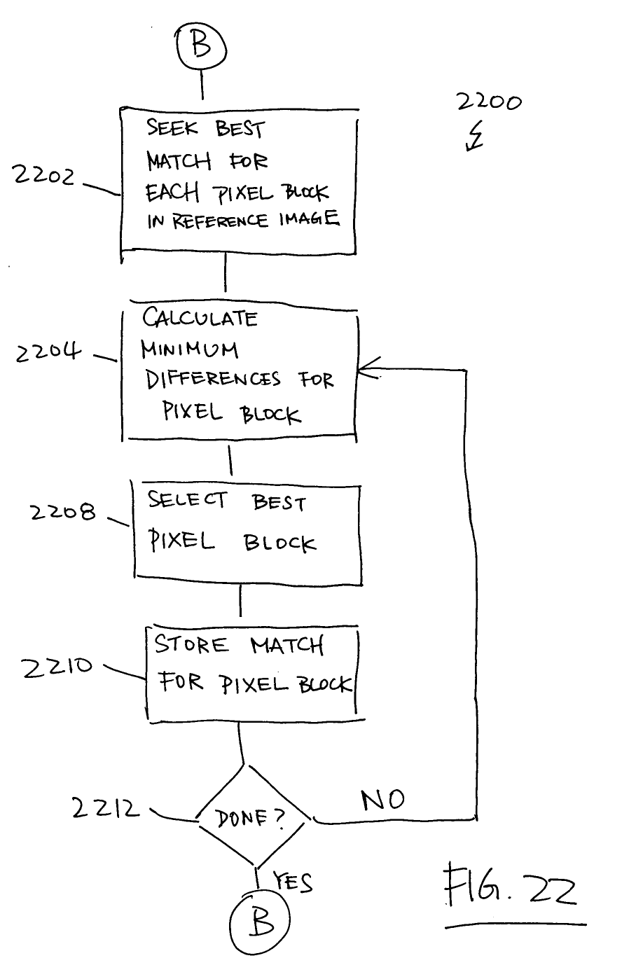

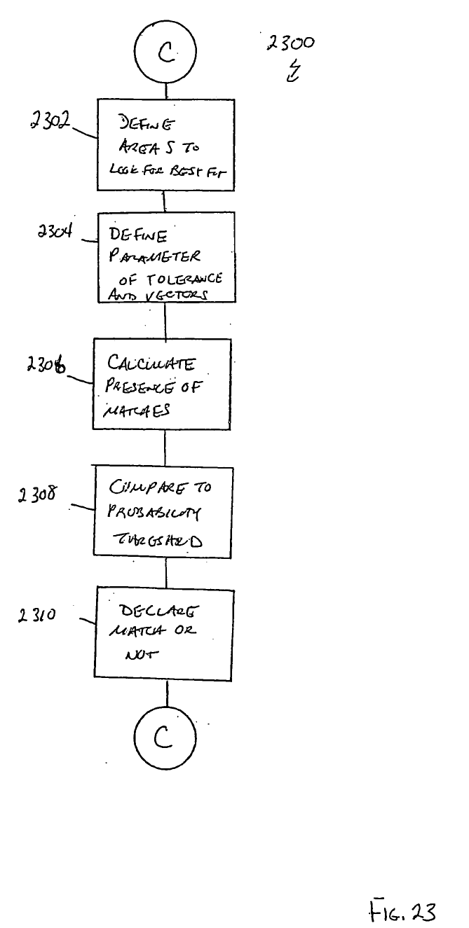

Referring to FIG. 18, a flow diagram 1800 discloses steps for an embodiment of an image matching system that uses patches of skin for image matching. In the following example, the skin patch is taken from the face of a target and a reference image. However, the present invention can be implemented with a patch of skin taken from anywhere on a person and compared to a corresponding reference patch. First, at a step 1802 the system obtains an image, such as of a face, such as by the user placing his or her face in front of the camera 102. Next at a step 1804, the image processing module 112 of the vision processing system 104 filters the initial image to obtain a filtered image that is more suitable for matching purposes. Further details of the filtering step are disclosed in a flow diagram 1900 of FIG. 19, which is connected to FIG. 18 by off-page connector “A”. The filtering step breaks down the image into a matrix of pixels, then averages the luminance of neighboring pixels about each pixel, then divides the image into binary pixels based on whether the average about a given pixel exceeds a threshold. Once an image is filtered at the step 1804, additional steps of a matching process take place. At a step 1808 the system may divide the filtered image into a plurality of pixel groups or blocks. The step 1808 may include an optional pre-processing step of normalizing the image, such as locating the eyes or other features of the face in the same location as the eyes of a reference image. In an image of columns and rows or lines, it is possible to divide it into blocks, for example into square blocks of dimension n. The number of such blocks is the product of two factors, the number of columns divided by n and the number of lines divided by n. We can consider such squares centered on the pixel (i, j) where i is between 0 and Column and j is between 0 and Lines, and both are integer multiples of n. Next, at a step 1810, the system obtains reference images from the data facility 108, which may be stored locally or at a remote host. Next, at a step 1812 the system searches a first reference image. The steps 1810 and 1812 can be repeated in sequence on in parallel for an arbitrarily large number of reference images. For example, there may be different images stored showing a user in different conditions, such as with a tan, without a tan, or the like. Next, at a step 1814 the system applies one or more algorithms, discussed in greater detail below, to determine differences between the captured image and a reference image. The additional steps are disclosed in connection with FIG. 22, which is connected to the flow diagram 1800 by off-page connector “B.” Once the differences are calculated at the step 1814, at a step 1818, it is determined whether there is a match. The steps for assessing and determining a match are disclosed in greater detail in connection with FIG. 23, which is connected to the flow diagram 1800 by off-page connector “C”. Once a match has been determined, the system can initiate actions at a step 1820, which may include allowing access to a facility, and which may optionally include storing the newly captured image in the reference database for future matching purposes. If there is no match, then the system can repeat the above steps. Because the threshold for a match can be made arbitrarily difficult, the probability of a false positive match can also be made arbitrarily low, so that it is appropriate to allow multiple, and even unlimited, attempts to match, unlike many conventional systems that must prevent large numbers of attempts because of the increasing probability of a false match that would allow improper access.

Referring to FIG. 19, a flow diagram 1900, connected via off-page connector “A” to the flow diagram 1800 of FIG. 18, discloses steps for accomplishing the filtering of the image at the step 1804 of FIG. 18. First, at a step 1902, to describe an image mathematically, one can consider it as a matrix of pixels pᵢⱼ. A pixel is a superposition of colors, usually the three colors red, blue, green, so one can take each pᵢⱼ as an element of vector space R³. The three components of this pixel represent the decomposition of a color according to this base of colors. For simplicity one can ignore the discrete character of each component and consider that every nuance of every color is allowed. Thus, an image of n lines and p column can be described as a matrix A∈Mₙₚ(R³).

The attributes of the pixels (and thus of the skin) can be thought of as a “visual skin print”. In one embodiment, the visual skin print is comprised of patterns of luminance generated by the texture, shape, and color of the skin. As described below, one technique for using this visual skin print involves digitizing the target image and comparing luminance values of the target and reference images.

At step 1904, the system defines luminance, L, of each pixel as a linear function from R³ to R, for example: L:(r,g,b)→0.3 r+0.59 g+0.11 b. Next, at a step 1908, one can define an average value of a pixel based on the luminance of surrounding pixels. For example, one can define Average as a function of a neighborhood of a pixel pᵢⱼ and give the arithmetical average of the luminance of all the pixels (p_{k,l}) with i−r≦k≦i+r and j−r≦1≦j+r as set out below. That is:

$$Average ( i , j , r ) = \frac{{\sum }_{k = i - r}^{i + r} {\sum }_{l = j - r}^{j + r} L ( {p}_{k , l} )}{{( 2 r + 1 )}^{2}}$$

Many other functions may fulfill the same role as this one, such as many kinds of discrete convolutions of the function L, or even non-linear or other functions.

Next, one can apply a filter to the pixels, based on the average of the neighborhood of the pixel. Thus, at a step 1910, one can define the filter, which is a binary flag on the value of Average:

$$Filter ( i , j , r , threshold ) = \{ \begin{matrix}1 & if & Average ( i , j , r ) - L ( {p}_{i , j} ) > threshold \\ 0 & if & Average ( i , j , r ) - L ( {p}_{i , j} ) \leq threshold\end{matrix}$$

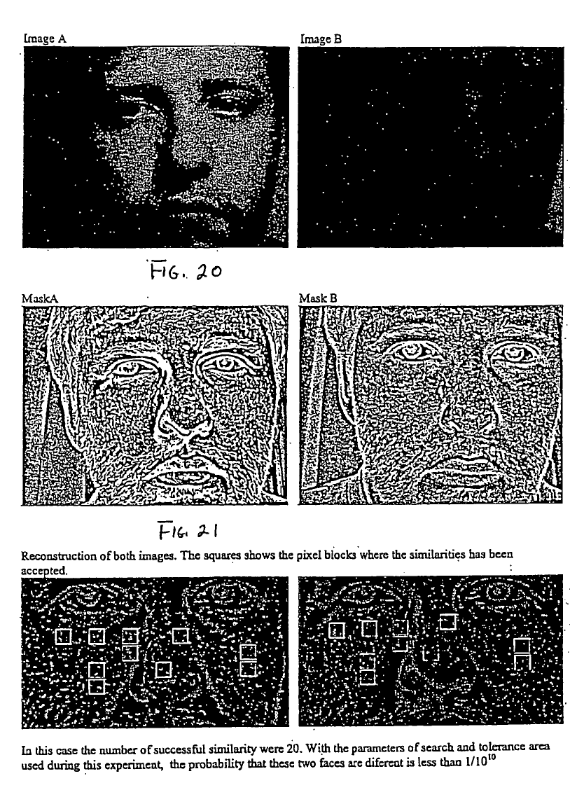

Thus, a plurality of pixels of varying color and luminance can be converted into a black and white image defined by pixels of value one and zero, with the one and zero value being established by whether or not such pixels have a luminance above a given threshold or not when compared to the average of surrounding pixels. At a step 1910, the system can output a filtered image. The filter makes contrasts in the image more drastic, allowing for better matching of important facial characteristics, such as scars, moles, and the like. Referring to FIGS. 20 and 21, an image of a face can be seen before (FIG. 20) and after (FIG. 21) the application of a filtering process such as that disclosed in connection with FIG. 19.

Referring to FIG. 22, steps for making a comparison between an acquired image and a reference image are further disclosed in a flow diagram 2200 that is connected to the flow diagram 1800 of FIG. 18 by off-page connector “B”. In the following we will give the index 1 to the quantities related to the reference image, the index 2 will be for the acquired image. Referring to the two images, I1 and I2, they have been divided in the same format Column×Lines. The images have already been normalized the images in a way that, for example, the position of the eyes is the same in both, located in a standard pattern. Both have been filtered, such as by the steps of the flow diagram 1900 of FIG. 19, into two binary images of substantially the same size. In essence the comparison of the images can be understood as an error function to judge, for two square blocks of the two images, how different they are.

In all the following, it is assumed that one has chosen a format of a square block of dimension n, where, for example in one embodiment, the image is divided into 5×12 blocks of n×n pixels. At the step 1808 of the flow diagram 1800 the first image was already divided into pixel square blocks, which are totally separated. There are Column/n*Lines/n such square blocks. Each square can be designed by B_{i1,j1} centered on the pixel (i1, j1) where i1 is between 0 and Column and j1 is between 0 and Lines, and both i1 and j1 are integer multiples of n. It should be noted that the methods described herein work with other block shapes, such a circles, rectangles and the like. Use of square blocks is indicated herein for simplicity of explanation.

At a step 2202, we initiate the computation, starting by computing for each square block of the first image what is the best fit in the second image, according to some error function. At a step 2204 we calculate for the first pixel block in the acquired image an error function that consists of the sum of the square of the differences between the pixels of that pixel block and the pixels of each of the possible pixel blocks in each of the reference image. The pixel block of the reference image is selected at the step 2208 as the “best” match for that pixel block. Then, at a step 2210, the system stores the location of the best matching pixel block from the reference image for the pixel block at hand. Then at a step 2212, the system determines whether there are additional pixel blocks to analyze. If so, then the steps are 2204 through 2210 are repeated until every pixel block has an identified best match, with a known location, in the reference image. When done, processing returns to the flow diagram 1800, as indicated by off-page connector B.

Determining the best fit at the step 2208 can be accomplished by a variety of techniques, including minimizing the sum of the differences, least squares, and other similar difference-calculating functions. When the process is complete, one can identify in the second image a block centered in (i₂,j₂) that best corresponds to the block B_{i1,j1} centered in (i₁,j₁) in the first image. This block is the ‘global best fit’ of B_{i1,j1}.

Referring to FIG. 23, a flow diagram 2300 depicts steps by which it may be assessed whether a first image captured by the camera 102 matches a second image retrieved from the data storage facility 108. The processes of FIG. 23 may be carried out by the image processing module 112 under control of the vision-based processor 204.

The location of best fit blocks of pixels that are generated can be used to determine if there is a match between the target image and a reference image. Let's consider 3 blocks (i₁,j₁), (i′₁,j′₁) and (i″₁,j″₁) in the first image. Let's call (i₂,j₂), (i′₂,j′₂) and (i″₂,j″₂) the best fit for respectively (i₁,j₁), (i′₁,j′₁) and (i″₁, j″₁). If (i₁,j₁), (i′₁,j′₁) and (i″₁,j″₁) are contiguous and (i₂,j₂), (i′₂,j′₂) and (i″₂,j″₂) are also contiguous in the same order, this will be considered a low probability event and will give an indication that the images may match. In one embodiment, this event will be given a score of 1 point. In that embodiment, the event made of 4 contiguous best fit blocks will be given a score of 2 points, 5 contiguous best fit blocks a score of 3 points, etc. In the embodiment of a 5×12 grid of blocks of pixels of skin, it has been found that when there are 8 points, a match has been found with a high probability. The likelihood of a false positive is statistically insignificant.

Morphing

The matching process depicted in FIG. 23 takes advantage of the principle of continuity, which is one particular way to assess the coherence of the optical flow, or morphing, between the two images, and in particular the special continuity of the face images to be matched. Generally, when one compares two images of the same face, if one has localized in both some particular point—that one can name M1 in the first image and M2 in the second one—, one can predict that a detail N1 that is just at the right of M1—in the first image—should correspond to a point N2 just at the right of M2 in the second image. Thus, one expects the relative position of Ni with respect to Mi to be the same, or almost the same, in both pictures. (One might have in mind that the two pictures are approximately deduced from each other by translating the image somehow). If there is doubt about the correspondence of the point Mi's in the two images, the belief that the images match is made stronger if the neighbor Ni's has a similar relative position in both. There is a lower chance of mistaking a correspondence twice than once. This step of matching reveals the reasonableness of the optical flow between the two images. As described below, the invention includes embodiments and techniques for determining the optical flow and the probability of a target image reasonably morphing into a reference image.

Continuing the analysis, one has two contradictory hypotheses that can be characterized as follows. Let H0 be the hypothesis that there are two images of TWO DIFFERENT PERSONS. Let H1 be the alternative hypothesis that there are two images of THE SAME PERSON.

One can define a neighbor of (i₁,j₁), called (k₁,l₁). In one embodiment, for some adequate norm called ∥ ∥, we mean by neighbor that ∥(i₁−k₁,j₁−l₁)∥≦1, one can call (i₂,j₂) the global best fit of(i₁,j₁), and (k₂,l₂) the global best fit of(k₁,l₁). In other embodiments, other definitions of neighbor are used. Now comes a fundamental probabilistic hypothesis. One “expects” when dealing with images of the same person (H1) (this is the argument of continuity) that (k₂,l₂) is a “neighbor” of (i₂,j₂), in the sense that ∥(k₂−i₂+i₁−k₁, l₂−j₂+j₁−l₁)∥ is close to 0. One “expects”, on the contrary, when images are from two different persons (H0), that (k₂,l₂) should be located in any place of his research area with an equal probability. For example, one can imagine that the error criterions between (k₁,l₁) and the possible (k₂,l₂) are a bunch of random values, independent and of same law. The maximum of these values should be itself uniformly distributed in the area of research.

First, at a step 2302, one defines an area of size S where the system looks for the best fit. Next, at a step 2304 the operator defines t, a parameter of tolerance and identifies V₁=(i₁−k₁,j₁−l₁) and V₂=(i₂−k₂,j₂−l₂), two vectors that give the relative position of the two blocks in both images. We have in mind that V₁ and V₂ are close when we are dealing of the same person (H1), and on the contrary independents and of uniform law when dealing in case of different persons (H0).

We focus now on the following event: {∥V₁−V₂∥<t/2}, one can define that event as ‘confirmation’. This event corresponds to an event of ‘continuity’ of the global best matches of (i₁,j₁) and (k₁,l₁) in the second image. Equivalently, this event may be described as the event where the global best match of (k₁,l₁) coincides with a ‘local’ best match of (k₁,l₁), only looked for in a small region around (i₂+k₁−i₁,j₂+l₁−j₁). This event corresponds to exactly (t−1)² possible values of V₂. As said before, this event is weakly probable in the hypothesis (H0) of different persons. The total number of possible values for V₂ is S. In the hypothesis (H0), according to the hypothesis of uniformity, we have:

P((k₂,l₂)“confirms”(i₁,j₁)|H0)=P(∥V₁−V₂∥<t/2|H0)=(t−1)²/S

One can make a similar calculus for others neighbors of (i₁,j₁), with the assumption that the place where all the best fit in I2 of these are independently placed, always following a random uniform law.

One finds that the probability that k neighbors of (i₁,j₁) out of p have their best fit in the same relative position in image I2 (modulo the tolerance) as in image I1 is, conditionally to the position of (i₂,j₂):

P(k‘confirmations’ among neighbors of (i₁,j₁)|H0)=[(t−1)²/S]^{k}[1−(t−1)²/S]^{p-k C}^{^{k}}^{p}

Consider a numerical example. Take (t−1)²/S=10%. Take k=3 and p=4. There is a probability of k confirmations of 0.36%. By having found 3 neighbors of (i₁,j₁) out of 4, under the assumption that images are different, the probability of this event is extremely small, i.e. the event is hard to believe.

The foregoing has dealt with only one block B_{i1,j1} of the image I1, and its immediate neighbors. The analysis supposed that the best fit of the neighbors may be uniformly distributed in the area of research.. If we process the same idea not starting from B_{i1,j1} but from another block, for example B_{i1′,j1′}, one can find first his absolute best fit in image I2, which one can call (i₂′,j₂′). In a similar way, one can then look for the local best fit of the neighbors of B_{i1′, j1′}, in an area of research centered on (i₂′,j₂′)

It is helpful to keep in mind that the local surface of research (t−1)² is very small, compared to the total surface of the image S. That means in practice that some local best fit searched in surface (t−1)² has few chances to be the global best fit in the whole image.

Now one can write generically for all the blocks of image I1, centered on the positions named (i_{1,1},j_{1,1}), (i_{1,2},j_{1,2}) . . . (i_{1,N},j_{1,N}). The likelihood of having, for the block k₁ ‘confirmations’ among the neighbors of (i_{1,1},j_{1,1}), for the second block k₂ ‘confirmations’ . . . until k_{N} confirmations for the ultimate block. Here ε stands for (t−1)²/S.

$$P ( {k}_{1} ‘ confirmations ’ of ( {i}_{1 , 1} , {j}_{1 , 1} ) , … {k}_{N} ‘ confirmations ’ of ( {i}_{1 , N} , {j}_{1 , N} ) \vert H0 ) = {\prod }_{q = 1}^{N} {{C}_{p}^{{k}_{q}} ( ϵ )}^{k g} {( 1 - ϵ )}^{p - {k}_{q}}$$

Recall that all this calculus takes place along the hypothesis that the two images are of two different persons. The preceding calculus gives us the joint rule of events of confirmation among all blocks. This means, in practice, one can evaluate with precision the probability of false positive match, i.e., the probability that one will attribute to two images of two different persons a high degree of similarity. In practice, the probability of wrong recognition is almost null.

Using this principle of continuity, which allows one to build a very discriminant rule to separate matches of neighboring pixel blocks that have occurred randomly, as opposed to matches due to real coherent correspondence because the faces containing the pixel blocks are the same, it is possible to complete the process of the flow diagram 2300 for determining a match. At a step 2306 the system calculates the best fit for each pixel block. At a step 2308 the system then determines a synthetic statistic indicator taking into account the occurrences of all ‘confirmation’ events. At a step 2310, the system then declares a match if the preceding statistic indicator was greater than the threshold defined at the step 2304, or a non-matched, if it is not so. Thus the reasonableness of the optical flow is quantified and determined by this particular method. Other methods may be used. We know the probability that the statistic indicator is stronger than its threshold, by accident, in H0, as opposed to because of a real match. Thus, by defining the threshold, it is possible for the operator to establish an arbitrarily rigorous criterion for matching, thus reducing the probability of a false positive to an arbitrarily low level.

While certain embodiments have been disclosed herein, one of ordinary skill in the art would recognize other embodiments, which should be understood to be encompassed herein, as limited only by the claims. All patents, patent applications and other documents referenced herein are hereby incorporated by reference.

Normalizing an Image

In one embodiment, an image is normalized before being analyzed. In another embodiment, a reference image is normalized. In one embodiment, an image is normalized with respect to size. In another embodiment, the image is normalized with respect to rotation. In yet another embodiment, the image is normalized with respect to horizontal and/or vertical position.

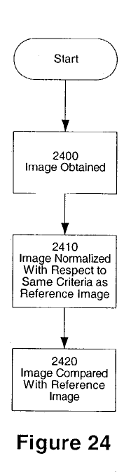

FIG. 24 illustrates the process of analyzing an image in accordance with one embodiment of the present invention. At block 2400, an image is obtained. At block 2410, the image is normalized with respect to the same criteria as a reference image. At block 2420, the image is compared with a reference image.

Reference Locations

In one embodiment, one or more reference locations are detected. The reference locations are used in the normalization process. In an example embodiment wherein the image is at least a partial image of a face, the eyes are located and used as the reference locations. In one embodiment, the center of the eye is used as a reference location. In another embodiment, the center of a portion of the eye (e.g., the pupil) is used as a reference location. In still another embodiment, another identifiable feature of an eye (e.g., an edge of the iris or eye white that is closest to the other eye) is used as a reference location.

FIG. 25 illustrates the process of normalizing an image in accordance with one embodiment of the present invention. At block 2500, an image is obtained. At block 2510, a reference location in the image is determined. At block 2520, the image is normalized such that the reference location is transformed to a desired location in the normalized image. In another embodiment, two reference locations are determined, and the image is normalized such that both reference locations are transformed to desired locations in the normalized image.

Alternative Reference Location

In one embodiment, when a desired reference location cannot be detected, an alternate reference location is selected. In one embodiment, the alternate reference location is a best-fit of the desired reference location. In an example embodiment, the desired reference location is an eye and the alternative reference location is the most eye-like location that can be detected in the image. In one embodiment, a reference image and an obtained image are both normalized using the alternate reference location.

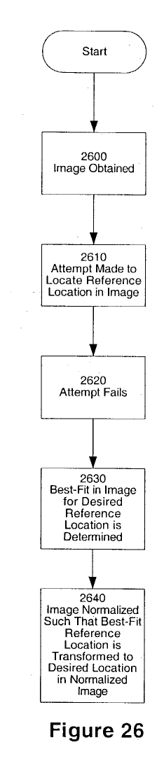

FIG. 26 illustrates the process of normalizing an image when a desired reference location cannot be detected in accordance with one embodiment of the present invention. At block 2600, an image is obtained. At block 2610, an attempt is made to locate a reference location in the image. At block 2620, the attempt fails. At block 2630, a best-fit in the image for a desired reference location is determined. At block 2640, the image is normalized such that the best-fit reference location is transformed to a desired location in the normalized image. In various embodiments, best-fit is determined using various methods (e.g., least difference, least mean squares, etc.) know to those of ordinary skill in the art.

In another embodiment, the alternate reference location is a location detected based upon a different set of search criteria from the originally desired reference location. In an example embodiment, the desired reference location is an eye and the alternative reference location is a nostril detected in the image.

FIG. 27 illustrates the process of normalizing an image when a desired reference location cannot be detected and an alternative search criterion is used to locate an alternative reference location in accordance with one embodiment of the present invention. At block 2700, an image is obtained. At block 2710, an attempt is made to locate a reference location in the image. At block 2720, the attempt fails. At block 2730, an alternative reference location in the image is determined using an alternative search criterion. At block 2740, the image is normalized such that the alternative reference location is transformed to a desired location in the normalized image.

In one embodiment, the image is normalized so that two reference locations are a specified distance from each other. In another embodiment, the image is normalized so that two reference locations are aligned consistent with a desired orientation. In still another embodiment, the image is normalized so that a reference location is in a desired location. In one embodiment, the normalized image is compared with another normalized image.

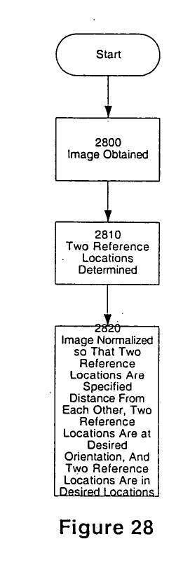

FIG. 28 illustrates the process of normalizing an image in accordance with one embodiment of the present invention. At block 2800, an image is obtained. At block 2810, two reference locations are determined. At block 2820, the image is normalized so that the two reference locations are a specified distance from each other (e.g., 255 pixels), the two reference locations are at a desired orientation (e.g., parallel with a horizontal axis), and the two reference locations are in desired locations. In one embodiment, the normalizations are accomplished by applying an appropriate matrix to the image. In other embodiments, other normalization techniques known to those of ordinary skill in the art are used.

Filters

In one embodiment, one or more filters are applied to the image. In one embodiment, a filter is applied to convert the image to a monochromatic image. In another embodiment, a filter is applied to convert the image to a grey scale image. In still another embodiment, a filter is applied to normalize a luminance level of the image. In one embodiment, a filter determines a luminance value (e.g., the average luminance of the image) and determines a difference between the luminance value and that of each pixel in the image.

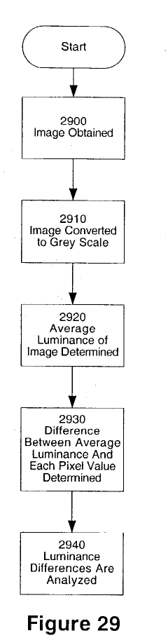

FIG. 29 illustrates the process of analyzing an image in accordance with one embodiment of the present invention. At block 2900, an image is obtained. At block 2910, the image is converted to a grey scale. At block 2920, an average luminance of the image is determined. At block 2930, the difference between the average luminance and each pixel value is determined. At block 2940, the luminance differences are analyzed.

In one embodiment, a filter clips undesired portions of an image. In an example embodiment, the filter modifies an image of a face such that only the area between the outside points of the eyes and between the bottom of the eyebrow to the top of the upper lip remains unclipped. In another example embodiment, the filter modifies an image of a face such that only the forehead region remains unclipped. In another example embodiment, the filter modifies an image of a face such that only the chin region remains unclipped. In other embodiments, the filter modifies an image of a face such that other regions of the face remain unclipped.

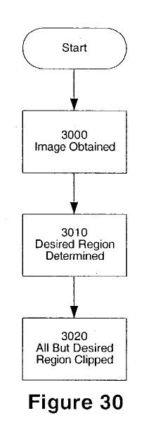

FIG. 30 illustrates the process of filtering an image to clip unwanted portions of the image in accordance with one embodiment of the present invention. At block 3000, an image is obtained. At block 3010, a desired region is determined. At block 3020, all but the desired region is clipped. In another embodiment, one or more undesired regions are determined and clipped; leaving a desired region remaining.

In one embodiment, a filter is applied to only a portion of an image. In another embodiment, a filter is used to shift a portion of an image to a new location. In yet another embodiment, a filter is used to rotate a portion of an image. In one embodiment, a filter is used to undo the changes to an image that would be incurred by moving a portion of the image in accordance with making a gesture starting from the reference image. In another embodiment, a filter is applied to a reference image.

In an example embodiment, a reference image is of a hand with its fingers arranged in a first configuration. A system of the example embodiment attempts to determine whether the obtained image is that of the same hand with fingers arranged in a second configuration. This can be accomplished in multiple ways. In accordance with one embodiment, a filter is applied to the reference image that transfers the first finger configuration into the second configuration (by rotating and/or translating appropriate portions of the image), and then the system compares the transformed reference image to the obtained image. In accordance with another embodiment, a filter is applied to the obtained image that transfers what may be the second configuration to what may be the first configuration (by rotating and/or translating appropriate portions of the image), and then compares the reference image and the filtered obtained image. In still another embodiment, the comparison of the obtained image and the reference image takes the expected differences caused by the change from the first configuration to the second configuration into account when determining whether a match has occurred.

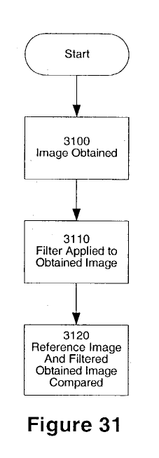

FIG. 31 illustrates the process of analyzing an image to detect specific changes between a reference image and an obtained image in accordance with one embodiment of the present invention. At block 3100, an image is obtained. At block 3110, a filter is applied to the obtained image. The filter is one that will transform the obtained image to one that matches the reference image if the obtained image represents a sought alteration of the reference image. At block 3120, the reference image and filtered obtained image are compared.

In one embodiment, a filter removes locations where correlations between sets of points in unrelated images are not sufficiently likely to be random. In an example embodiment, a filter removes contours and/or edges of features (e.g., the contours of a nose, mouth, eye, hairline, lip, eyebrow, ear, or fingernail). Thus, in one embodiment, the image is filtered to result in an image of the skin of a body portion without edges caused by a skeletal, cartilagous, or muscular feature that are detectable beyond an edge-detecting threshold level.

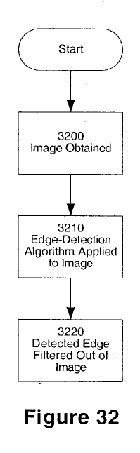

FIG. 32 illustrates the process of filtering to remove regions associated with non-randomly occurring properties in accordance with one embodiment of the present invention. At block 3200, an image is obtained. At block 3210, an edge-detection algorithm is applied to the image. At block 3220, a detected edge is filtered out of the image.

In one embodiment, the image is partitioned into blocks of pixels. In one embodiment, the pixel blocks are a contiguous rectangular region of the image. In other embodiments, pixel blocks are non-rectangular regions. In still other embodiments, pixel blocks are not contiguous. In one embodiment, a filter is applied to a block to distort the block into a different shape. In another embodiment, a filter is applied to a block to distort the block into a different size. Thus, a reference image may be compared to an obtained image wherein the obtained image may be of the same object in the reference image, but viewed from a different angle. In an example embodiment, the reference image is a front-on view of a portion of facial skin and the obtained image is a side-on view of the same portion of facial skin.

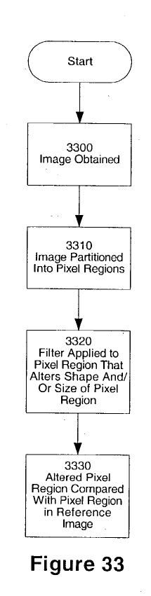

FIG. 33 illustrates the process of analyzing an image when the image may represent an object viewed from a different orientation than that of a reference image of an object in accordance with one embodiment of the present invention. At block 3300, an image is obtained. At block 3310, the image is partitioned into pixel regions (or blocks). At block 3320, a filter is applied to a pixel region that alters the shape and/or size of the pixel region. At block 3330, the altered pixel region is compared with a pixel region in a reference image. In one embodiment, a filter is applied before an image is partitioned. In another embodiment, a filter is applied after an image is partitioned.

Image Analysis

In one embodiment, an image is normalized, filtered, and then compared to a reference image. A determination is made regarding the likelihood of characteristics of the image randomly matching characteristics of the reference image. If the likelihood is smaller than a threshold value, the system determines that the image and the reference image match.

In one embodiment, the image (or, in other embodiments, the reference image) is partitioned into a plurality of pixel regions. A pixel region in one image is mapped to a best-fit region in the other image. The positional relationship between the pixel region and its neighbor is compared with the positional relationship between the two best-fit pixel regions to determine whether this neighbor pair indicate a match. In one embodiment, the process is repeated for one or more other pixel regions, and an overall match probability is determined by the number of match/no-match determinations. In another embodiment, the above process is repeated for another pixel region (typically, a region other than previously examined pixel regions or neighbor regions) to obtain a new overall match probability. In one embodiment, after a number of regions and neighbors are examined, it is determined whether the overall match probability exceeds a threshold value. If it does, the system has analyzed the image and determined that a match has occurred. In one embodiment, an obtained image that is determined to be a match is added to a database of reference images.

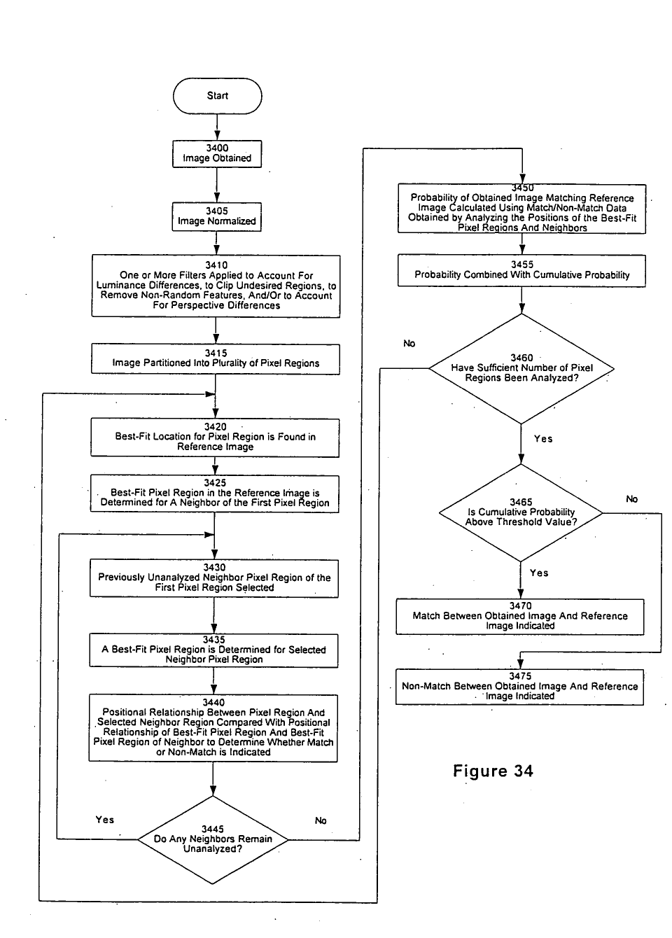

FIG. 34 illustrates the process of probabilistic image analysis in accordance with one embodiment of the present invention. At block 3400, an image is obtained. At block 3405, the image is normalized. At block 3410, one or more filters are applied to account for luminance differences, to clip undesired regions, to remove non-random features (e.g., edges), and/or to account for perspective differences. At block 3415, the image is partitioned into a plurality of pixel regions. At block 3420, a best-fit location for a pixel region is found in a reference image. At block 3425, a best-fit pixel region in the reference image is determined for a neighbor of the first pixel region.

At block 3430, a previously unanalyzed neighbor pixel region of the first pixel region is selected. At block 3435, a best-fit pixel region in the best-fit location is determined for the selected neighbor pixel region. At block 3440, the positional relationship between the pixel region and the selected neighbor region is compared with the positional relationship of the best-fit pixel region and the second best-fit pixel region of its neighbor to determine whether a match or a non-match is indicated. At block 3445, it is determined whether any neighbors remain unanalyzed. If a neighbor remains unanalyzed, the process repeats at block 3430. If no neighbors remain unanalyzed, at block 3450, a probability of the obtained image matching the reference image is calculated using the match/non-match data obtained by analyzing the positions of the best-fit pixel regions and their neighbors. In one embodiment, the probability is that of a non-match rather than that of a match. The relationship between match and non-match probabilities is that they sum to 1, so one of ordinary skill in the art could use either method.

At block 3455, the probability is combined with a cumulative probability. At block 3460, it is determined if a sufficient number of pixel regions have been analyzed. If a sufficient number of pixel blocks have not been analyzed, the process repeats at block 3420. In one embodiment, when 3420 is repeated, a previously unanalyzed pixel region is chosen. In another embodiment, a previously analyzed pixel region may be chosen again, but a pixel region which has not been previously analyzed is selected in block 3425.

If a sufficient number of pixel regions have been analyzed, at block 3465, it is determined whether the cumulative probability is above a threshold value. In another embodiment, it is determined whether the cumulative probability is equal to or greater than a threshold value. If the cumulative probability is greater than a threshold value, at block 3470, a match between the obtained image and the reference image is indicated. If the cumulative probability is not greater than a threshold value, at block 3475, a non-match between the obtained image and the reference image is indicated.

Embodiment of Computer Execution Environment (Hardware)

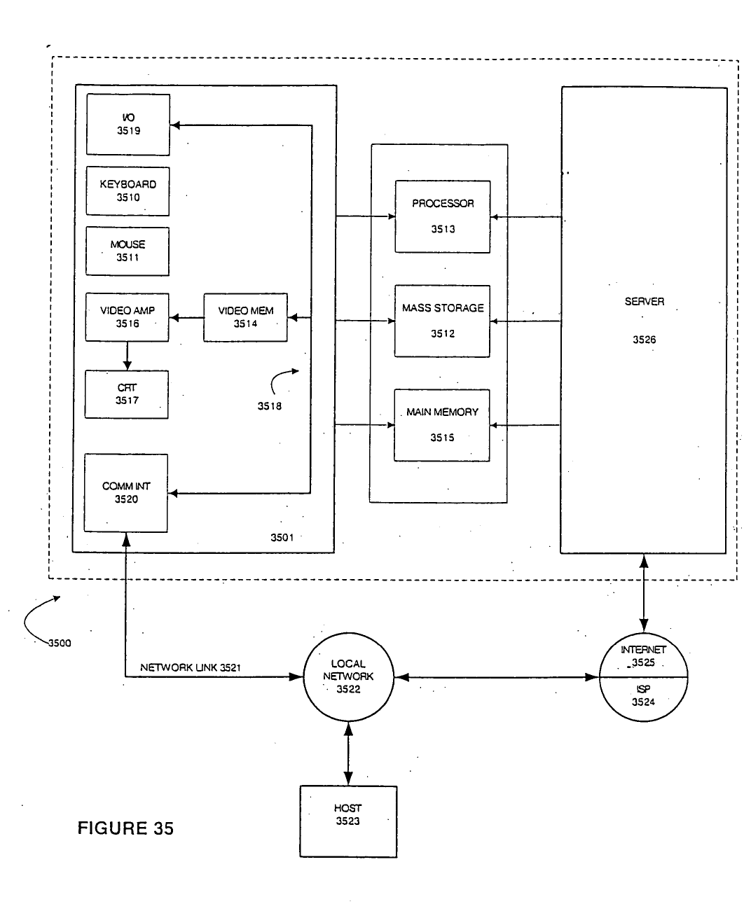

An embodiment of the invention can be implemented as computer software in the form of computer readable program code executed in a general purpose computing environment such as environment 3500 illustrated in FIG. 35. A keyboard 3510 and mouse 3511 are coupled to a system bus 3518. The keyboard and mouse are for introducing user input to the computer system and communicating that user input to central processing unit (CPU) 3513. Other suitable input devices may be used in addition to, or in place of, the mouse 3511 and keyboard 3510. I/O (input/output) unit 3519 coupled to bi-directional system bus 3518 represents such I/O elements as a printer, A/V (audio/video) I/O, etc.

Computer 3501 may include a communication interface 3520 coupled to bus 3518. Communication interface 3520 provides a two-way data communication coupling via a network link 3521 to a local network 3522. For example, if communication interface 3520 is an integrated services digital network (ISDN) card or a modem, communication interface 3520 provides a data communication connection to the corresponding type of telephone line, which comprises part of network link 3521. If communication interface 3520 is a local area network (LAN) card, communication interface 3520 provides a data communication connection via network link 3521 to a compatible LAN. Wireless links are also possible. In any such implementation, communication interface 3520 sends and receives electrical, electromagnetic or optical signals which carry digital data streams representing various types of information.

Network link 3521 typically provides data communication through one or more networks to other data devices. For example, network link 3521 may provide a connection through local network 3522 to local server computer 3523 or to data equipment operated by ISP 3524. ISP 3524 in turn provides data communication services through the world wide packet data communication network now commonly referred to as the “Internet” 3525. Local network 3522 and Internet 3525 both use electrical, electromagnetic or optical signals which carry digital data streams. The signals through the various networks and the signals on network link 3521 and through communication interface 3520, which carry the digital data to and from computer 3500, are exemplary forms of carrier waves transporting the information.

Processor 3513 may reside wholly on client computer 3501 or wholly on server 3526 or processor 3513 may have its computational power distributed between computer 3501 and server 3526. Server 3526 symbolically is represented in FIG. 35 as one unit, but server 3526 can also be distributed between multiple “tiers”. In one embodiment, server 3526 comprises a middle and back tier where application logic executes in the middle tier and persistent data is obtained in the back tier. In the case where processor 3513 resides wholly on server 3526, the results of the computations performed by processor 3513 are transmitted to computer 3501 via Internet 3525, Internet Service Provider (ISP) 3524, local network 3522 and communication interface 3520. In this way, computer 3501 is able to display the results of the computation to a user in the form of output.

Computer 3501 includes a video memory 3514, main memory 3515 and mass storage 3512, all coupled to bi-directional system bus 3518 along with keyboard 3510, mouse 3511 and processor 3513. As with processor 3513, in various computing environments, main memory 3515 and mass storage 3512, can reside wholly on server 3526 or computer 3501, or they may be distributed between the two.

The mass storage 3512 may include both fixed and removable media, such as magnetic, optical or magnetic optical storage systems or any other available mass storage technology. Bus 3518 may contain, for example, thirty-two address lines for addressing video memory 3514 or main memory 3515. The system bus 3518 also includes, for example, a 32-bit data bus for transferring data between and among the components, such as processor 3513, main memory 3515, video memory 3514 and mass storage 3512. Alternatively, multiplex data/address lines may be used instead of separate data and address lines.

In one embodiment of the invention, the microprocessor is manufactured by Intel, such as the 80×86 or Pentium-typed processor. However, any other suitable microprocessor or microcomputer may be utilized. Main memory 3515 is comprised of dynamic random access memory (DRAM). Video memory 3514 is a dual-ported video random access memory. One port of the video memory 3514 is coupled to video amplifier 3516. The video amplifier 3516 is used to drive the cathode ray tube (CRT) raster monitor 3517. Video amplifier 3516 is well known in the art and may be implemented by any suitable apparatus. This circuitry converts pixel data stored in video memory 3514 to a raster signal suitable for use by monitor 3517. Monitor 3517 is a type of monitor suitable for displaying graphic images.

Computer 3501 can send messages and receive data, including program code, through the network(s), network link 3521, and communication interface 3520. In the Internet example, remote server computer 3526 might transmit a requested code for an application program through Internet 3525, ISP 3524, local network 3522 and communication interface 3520. The received code may be executed by processor 3513 as it is received, and/or stored in mass storage 3512, or other non-volatile storage for later execution. In this manner, computer 3500 may obtain application code in the form of a carrier wave. Alternatively, remote server computer 3526 may execute applications using processor 3513, and utilize mass storage 3512, and/or video memory 3515. The results of the execution at server 3526 are then transmitted through Internet 3525, ISP 3524, local network 3522 and communication interface 3520. In this example, computer 3501 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for probabilistic image analysis is described in conjunction with one or more specific embodiments. The invention is defined by the following claims and their full scope and equivalents.

We claim:

1. A method of analyzing an image comprising:
acquiring a first surface area of a surface location of an image of a person to be analyzed;
retrieving a second surface area of the same surface location of a reference image;
comparing characteristic values of said first surface area and said second surface area;
calculating a score from said comparison, said score representing a likelihood that said first and second surface areas are from the same person.

2. The method of claim 1 wherein said first surface area and said second surface comprise skin.

3. The method of claim 2 wherein said characteristic values comprise a visual skin print of said skin.

4. The method of claim 3 wherein said visual skin print comprises patterns of luminance of said skin.

5. The method of claim 4 wherein said patterns of luminance are generated by the texture, shape, and colors of said skin.

6. The method of claim 1 wherein said first surface area is filtered and digitized into pixels prior to said step of comparing.

7. The method of claim 6 wherein said step of comparing comprises dividing target blocks of pixels and reference blocks of pixels into n×n grids, for a block in said target grid finding a best-fit block in said reference grid, determining a match when a threshold number of blocks of said target grid have best-fit matches in said reference grid.

8. A method of analyzing an image comprising:
acquiring a first surface area of a surface location of an image of a person to be analyzed;
retrieving a second surface area of the same surface location of a reference image;
comparing a pattern of luminance of said first surface area with a pattern of luminance of said second surface area;
calculating a score from said comparison, said score representing a likelihood that said first and second surface areas are from the same person.

9. The method of claim 8 wherein said comparing step comprises:
identifying a first group of pixels in said first surface area;
selecting a second group of pixels from said second surface area that is a best match for said first group of pixels;
repeating the above steps for at least one more group of pixels in said first and second surface areas;
comparing the relative locations of said pixel groups in said first and second surface areas;
determing a probability that the relative locations occurred randomly.

10. A method of analyzing an image comprising:
acquiring a first surface area of a target image of a person to be analyzed;
retrieving a second surface area of a reference image;
morphing said first surface area to said second surface area;
identifying a match when said morphing step is accomplished in a a reasonable manner.

11. A method of analyzing an image comprising:
acquiring a first surface area of a target image of a person to be analyzed;
retrieving a second surface area of a reference image;
computing an optical flow required between said first surface area and said second surface area;
identifying a match when said optical flow is reasonable.

12. A method of triggering a computer to select one of a plurality of environments, each environment associated with one of a plurality of users comprising:
scanning a zone near said computer with a camera, said camera receiving an image of said zone;
identifying a presence of a person in said zone;
comparing attributes of said person with attributes of said plurality of users;
initializing an environment associated with said person when said attributes of said person match attributes of one of said plurality of users.

13. The method of claim 12 wherein said scanning continues during operation of said computer by said matching person and said environment is deselected from said computer when said person is not present in said zone.
